(19) United States
(12) Patent Application Publication
(10) Pub. No.: US 2026/0230891 A1
(43) Pub. Date: Aug. 6, 2026

(54) TECHNIQUES FOR INDICATING USER EQUIPMENT FEATURES ASSOCIATED WITH CROSS-LINK INTERFERENCE MEASUREMENT AND REPORTING

(71) Applicant: QUALCOMM Incorporated, San Diego, CA (US)

(72) Inventors: Muhammad Sayed Khairy ABDELGHAFFAR, San Jose, CA (US); Qian ZHANG, Basking Ridge, NJ (US); Abdelrahman Mohamed IBRAHIM, San Diego, CA (US); Jae Ho RYU, San Diego, CA (US)

(21) Appl. No.: 19/468,422

(22) Filed: Feb. 3, 2026

Related U.S. Application Data
(60) Provisional application No. 63/755,046, filed on Feb. 6, 2025.

(51) Int. Cl. H04W 24/10

(52) U.S. Cl. CPC H04W 24/10

(57) ABSTRACT

Various aspects of the present disclosure generally relate to wireless communication. In some aspects, a user equipment (UE) may transmit, via capability signaling, an indication of one or more UE features associated with layer 1 (L1) cross-link interference (CLI) measurement and reporting, wherein the one or more UE features includes a support of semi-persistent CLI resources for L1-based aperiodic CLI reporting. The UE may receive, based at least in part on the capability signaling, a configuration that indicates an L1 CLI resource for the L1 CLI measurement and a configuration for CLI reporting. The UE may transmit a CLI report based at least in part on the configuration for CLI reporting, wherein the CLI report indicates an aperiodic CLI measurement associated with the L1 CLI resource. Numerous other aspects are described.

### CROSS-REFERENCE TO RELATED APPLICATION

This Patent Application claims priority to U.S. Provisional Patent Application No. 63/755,046, filed on February 6, 2025, entitled “TECHNIQUES FOR INDICATING USER EQUIPMENT FEATURES ASSOCIATED WITH CROSS-LINK INTERFERENCE MEASUREMENT AND REPORTING,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with indicating user equipment features associated with cross-link interference measurement and reporting.

### DESCRIPTION OF RELATED ART

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

In some implementations, an apparatus for wireless communication includes one or more memories; and one or more processors coupled to the one or more memories, the one or more processors individually or collectively configured to: transmit, via capability signaling, an indication of one or more user equipment (UE) features associated with layer 1 (L1) cross-link interference (CLI) measurement and reporting; receive, based at least in part on the capability signaling, a configuration that indicates an L1 CLI resource for the L1 CLI measurement and a configuration for CLI reporting; and transmit a CLI report based at least in part on the configuration for CLI reporting, wherein the CLI report indicates an aperiodic CLI measurement associated with the L1 CLI resource.

In some implementations, an apparatus for wireless communication includes one or more memories; and one or more processors coupled to the one or more memories, the one or more processors individually or collectively configured to: receive, via capability signaling, an indication of one or more UE features associated with L1 CLI measurement and reporting; transmit, based at least in part on the capability signaling, a configuration that indicates an L1 CLI resource for the L1 CLI measurement and a configuration for CLI reporting; and receive a CLI report based at least in part on the configuration for CLI reporting, wherein the CLI report indicates an aperiodic CLI measurement associated with the L1 CLI resource.

In some implementations, a method of wireless communication performed by a UE includes transmitting, via capability signaling, an indication of one or more UE features associated with L1 CLI measurement and reporting; receiving, based at least in part on the capability signaling, a configuration that indicates an L1 CLI resource for the L1 CLI measurement and a configuration for CLI reporting; and transmitting a CLI report based at least in part on the configuration for CLI reporting, wherein the CLI report indicates an aperiodic CLI measurement associated with the L1 CLI resource.

In some implementations, a method of wireless communication performed by a network node includes receiving, via capability signaling, an indication of one or more UE features associated with L1 CLI measurement and reporting; transmitting, based at least in part on the capability signaling, a configuration that indicates an L1 CLI resource for the L1 CLI measurement and a configuration for CLI reporting; and receiving a CLI report based at least in part on the configuration for CLI reporting, wherein the CLI report indicates an aperiodic CLI measurement associated with the L1 CLI resource.

In some implementations, a non-transitory computer-readable medium storing a set of instructions for wireless communication includes one or more instructions that, when executed by one or more processors of a UE, cause the UE to: transmit, via capability signaling, an indication of one or more UE features associated with L1 CLI measurement and reporting; receive, based at least in part on the capability signaling, a configuration that indicates an L1 CLI resource for the L1 CLI measurement and a configuration for CLI reporting; and transmit a CLI report based at least in part on the configuration for CLI reporting, wherein the CLI report indicates an aperiodic CLI measurement associated with the L1 CLI resource.

In some implementations, a non-transitory computer-readable medium storing a set of instructions for wireless communication includes one or more instructions that, when executed by one or more processors of a network node, cause the network node to: receive, via capability signaling, an indication of one or more UE features associated with L1 CLI measurement and reporting; transmit, based at least in part on the capability signaling, a configuration that indicates an L1 CLI resource for the L1 CLI measurement and a configuration for CLI reporting; and receive a CLI report based at least in part on the configuration for CLI reporting, wherein the CLI report indicates an aperiodic CLI measurement associated with the L1 CLI resource.

In some implementations, an apparatus for wireless communication includes means for transmitting, via capability signaling, an indication of one or more apparatus features associated with L1 CLI measurement and reporting; means for receiving, based at least in part on the capability signaling, a configuration that indicates an L1 CLI resource for the L1 CLI measurement and a configuration for CLI reporting; and means for transmitting a CLI report based at least in part on the configuration for CLI reporting, wherein the CLI report indicates an aperiodic CLI measurement associated with the L1 CLI resource.

In some implementations, an apparatus for wireless communication includes means for receiving, via capability signaling, an indication of one or more UE features associated with L1 CLI measurement and reporting; means for transmitting, based at least in part on the capability signaling, a configuration that indicates an L1 CLI resource for the L1 CLI measurement and a configuration for CLI reporting; and means for receiving a CLI report based at least in part on the configuration for CLI reporting, wherein the CLI report indicates an aperiodic CLI measurement associated with the L1 CLI resource.

In some implementations, an apparatus for wireless communication includes one or more memories; and one or more processors coupled to the one or more memories, the one or more processors individually or collectively configured to: transmit, via capability signaling, an indication of one or more UE features associated with L1 CLI measurement and reporting, wherein the one or more UE features includes a support of semi-persistent CLI resources for L1-based aperiodic CLI reporting; receive, based at least in part on the capability signaling, a configuration that indicates an L1 CLI resource for the L1 CLI measurement and a configuration for CLI reporting; and transmit a CLI report based at least in part on the configuration for CLI reporting, wherein the CLI report indicates an aperiodic CLI measurement associated with the L1 CLI resource.

In some implementations, an apparatus for wireless communication includes one or more memories; and one or more processors coupled to the one or more memories, the one or more processors individually or collectively configured to: receive, via capability signaling, an indication of one or more UE features associated with L1 CLI measurement and reporting, wherein the one or more UE features includes a support of semi-persistent CLI resources for L1-based aperiodic CLI reporting; transmit, based at least in part on the capability signaling, a configuration that indicates an L1 CLI resource for the L1 CLI measurement and a configuration for CLI reporting; and receive a CLI report based at least in part on the configuration for CLI reporting, wherein the CLI report indicates an aperiodic CLI measurement associated with the L1 CLI resource.

In some implementations, a method of wireless communication performed by a UE includes transmitting, via capability signaling, an indication of one or more UE features associated with L1 CLI measurement and reporting, wherein the one or more UE features includes a support of semi-persistent CLI resources for L1-based aperiodic CLI reporting; receiving, based at least in part on the capability signaling, a configuration that indicates an L1 CLI resource for the L1 CLI measurement and a configuration for CLI reporting; and transmitting a CLI report based at least in part on the configuration for CLI reporting, wherein the CLI report indicates an aperiodic CLI measurement associated with the L1 CLI resource.

In some implementations, a method of wireless communication performed by a network node includes receiving, via capability signaling, an indication of one or more UE features associated with L1 CLI measurement and reporting, wherein the one or more UE features includes a support of semi-persistent CLI resources for L1-based aperiodic CLI reporting; transmitting, based at least in part on the capability signaling, a configuration that indicates an L1 CLI resource for the L1 CLI measurement and a configuration for CLI reporting; and receiving a CLI report based at least in part on the configuration for CLI reporting, wherein the CLI report indicates an aperiodic CLI measurement associated with the L1 CLI resource.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless network, in accordance with the present disclosure.

FIG. 2 is a diagram illustrating an example disaggregated network node architecture, in accordance with the present disclosure.

FIGS. 3-4 are diagrams illustrating examples associated with indicating user equipment (UE) features associated with cross-link interference measurement and reporting, in accordance with the present disclosure.

FIG. 5 is a flowchart illustrating an example process performed, for example, by a UE, in accordance with the present disclosure.

FIG. 6 is a flowchart illustrating an example process performed, for example, by a network node, in accordance with the present disclosure.

FIGS. 7-8 are diagrams of example apparatuses for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In a wireless communications network, a user equipment (UE) may report, to a network node, one or more UE features via one or more UE capability fields. The one or more UE features may notify the network node of various UE capabilities. The one or more UE features may be related to various categories, such as channel state information (CSI) reporting. For example, the one or more UE features associated with the CSI reporting may include a supported maximum number of configured non-zero-power (NZP) CSI reference signal (CSI-RS) (NZP-CSI-RS) resources per component carrier (CC), a supported maximum number of ports across all configured NZP-CSI-RS resources per CC, a supported maximum number of configured CSI interference management (CSI-IM) resources per CC, a supported maximum number of simultaneous NZP-CSI-RS resources in active bandwidth parts (BWPs) across all CCs, a supported maximum number of simultaneous NZP-CSI-RS resources per CC, a supported maximum total number of CSI-RS ports in simultaneous NZP-CSI-RS resources in active BWPs across all CCs, and/or a supported maximum total number of CSI-RS ports in simultaneous NZP-CSI-RS resources per CC. The network node may configure CSI resources, CSI measurements, and/or CSI reporting based at least in part on the one or more UE features.

In the wireless communications network, a full duplex (FD) operation may involve an in-band full duplex (IBFD) operation, in which a transmission and a reception may occur on the same time and frequency resource. A downlink direction and an uplink direction may share the same IBFD time/frequency resource based at least in part on a full or partial overlap. Alternatively, the FD operation may involve a subband full duplex (SBFD) (or flexible duplex) operation, in which a transmission and a reception may occur at the same time but on different frequency resources. A downlink resource may be separated from an uplink resource in a frequency domain. In the SBFD operation, no downlink and uplink overlap in frequency may occur.

In the wireless communications network, the FD operation (e.g., the SBFD operation) may increase a likelihood of cross-link interference (CLI). CLI may occur when a first signal from a first link interferes with a second signal from a second link. For example, CLI may occur when an uplink transmission associated with a first UE or a first network node interferes with a downlink transmission associated with a second UE or a second network node. CLI may occur between network nodes and/or between UEs. CLI may degrade a signal quality and reduce a network performance.

In the wireless communications network, the UE may not be configured to report one or more UE features related to layer 1 (L1) CLI measurements and reporting. The one or more UE features used to indicate the UE capabilities may not include UE features related to L1 CLI measurements and reporting. The UE may be unable to appropriately perform L1 CLI measurements and report the L1 CLI measurements to the network node, which may prevent the network node from mitigating CLI. Further, the one or more UE features may not include UE features related to counting CLI reports in relation to CSI reports that are already reported by the UE to the network node. The UE may be limited in a number of CSI reports that are able to be measured and processed simultaneously in a CC, and the UE may not be configured to handle both CSI reports not including CLI reports and CSI reports that include CLI reports. Without suitable UE capability reporting by the UE to the network node, the CLI may not be properly mitigated, which may degrade an overall system performance.

Various aspects relate generally to UE features. Some aspects more specifically relate to indicating UE features associated with CLI measurement and reporting. In some examples, a UE may transmit, to the network node via capability signaling, an indication of one or more UE features associated with L1 CLI measurement and reporting. The capability signaling may indicate a number of CSI reports for which the UE is able to measure and process reference signals simultaneously in a CC, where a CSI report may include a CLI report. Alternatively, capability signaling may indicate a number of CSI reports for which the UE is able to measure and process CLI resources simultaneously in a CC, where the CSI report may include the CLI report. The CLI report may be counted based at least in part on the capability signaling. The one or more features may include a support of aperiodic CLI reporting associated with aperiodic CLI resources. The one or more features may include a CLI report quantity. The one or more features may include a maximum number of aperiodic CSI report settings per BWP for the CLI report. The one or more features may include a maximum number of CLI reports for which the UE is able to measure and process CLI resources simultaneously in a CC. The one or more features may include a maximum number of CLI reports for which the UE is able to measure and process CLI resources simultaneously across one or more CCs. The UE may receive, from the network node and based at least in part on the capability signaling, a configuration that indicates an L1 CLI resource for the L1 CLI measurement and a configuration for CLI reporting. The UE may transmit, to the network node, the CLI report based at least in part on the configuration, where the CLI report may indicate an aperiodic CLI measurement associated with the L1 CLI resource.

Particular aspects of the subject matter described in this disclosure can be implemented to realize one or more of the following potential advantages. In some examples, by configuring the UE to report one or more UE features associated with L1 CLI measurement and reporting, the described techniques can be used by the UE to receive a configuration based at least in part on the one or more UE features and transmit a CLI report based at least in part on the configuration for CLI reporting. The configuration, which may indicate the L1 CLI resource, may depend on the one or more UE features indicated in the capability signaling. The CLI report that indicates the aperiodic CLI measurement associated with the L1 CLI resource may be in accordance with the configuration. By configuring the capability signaling to indicate the number of CSI reports for which the UE is able to measure and process simultaneously, the UE may be able to maximize a number of CSI reports that are simultaneously processed, where the CSI reports may include L1 CLI measurements and non-L1-CLI measurements. By configuring the UE to appropriately measure and report L1 CLI, the network node may be able to perform suitable actions to mitigate the CLI, thereby improving an overall system performance.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

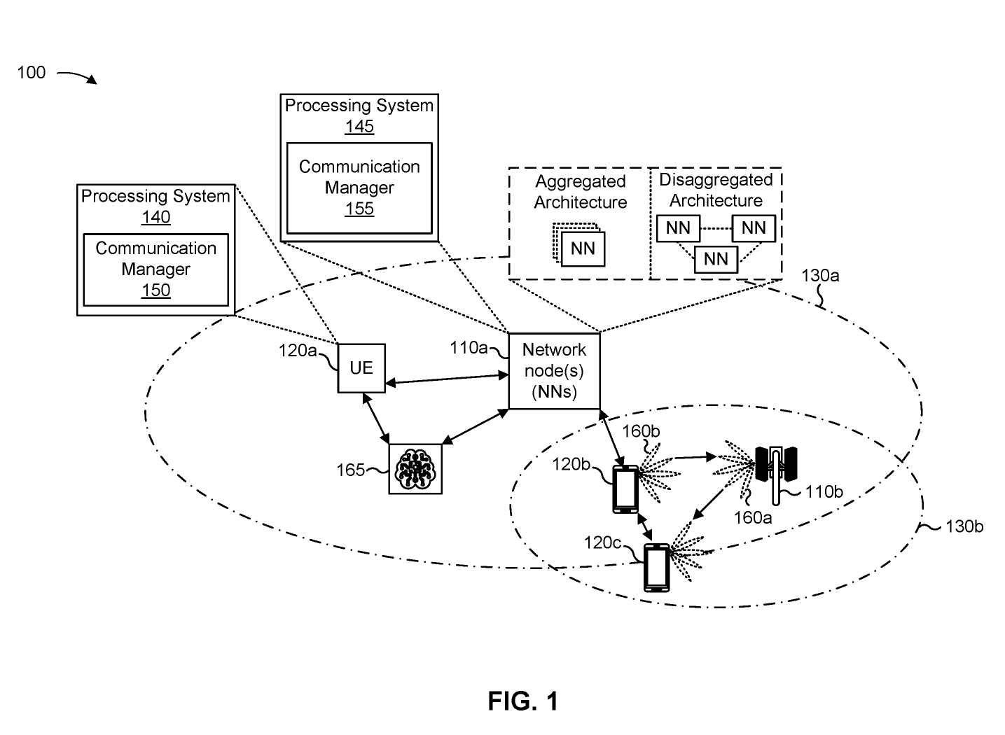

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A processing system (e.g., the processing system 140 and/or the processing system 145) may generally be a system or a series of machines or components that receives inputs and processes the inputs to produce a set of outputs (which may be passed to other systems or components of, for example, the UE 120). For example, the processing system 140 of the UE 120 may be a system that includes the various other components or subcomponents of the UE 120. The processing system 140 of the network node 110 may be a system that includes the various other components or subcomponents of the network node 110.

The processing system 145 of the network node 110 may interface with one or more other components of the network node 110, may process information received from one or more other components (such as inputs or signals), or may output information to one or more other components. For example, a chip or modem of the network node 110 may include the processing system 145, a first interface to receive or obtain information, and a second interface to output, transmit, or provide information. In some examples, the first interface may be an interface between the processing system 145 of the chip or modem and a receiver, such that the network node 110 may receive information or signal inputs, and the information may be passed to the processing system 145. In some examples, the second interface may be an interface between the processing system 145 of the chip or modem and a transmitter, such that the network node 110 may transmit information output from the chip or modem. Similarly, the processing system 140 of the UE 120 may interface with one or more other components of the UE 120, may process information received from one or more other components (such as inputs or signals), or may output information to one or more other components. For example, a chip or modem of the UE 120 may include the processing system 140, a first interface to receive or obtain information, and a second interface to output, transmit, or provide information. In some examples, the first interface may be an interface between the processing system 140 of the chip or modem and a receiver, such that the UE 120 may receive information or signal inputs, and the information may be passed to the processing system 140. In some examples, the second interface may be an interface between the processing system 140 of the chip or modem and a transmitter, such that the UE 120 may transmit information output from the chip or modem. A person having ordinary skill in the art will readily recognize that the second interface described above also may obtain or receive information or signal inputs, and the first interface described above may also output, transmit, or provide information.

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

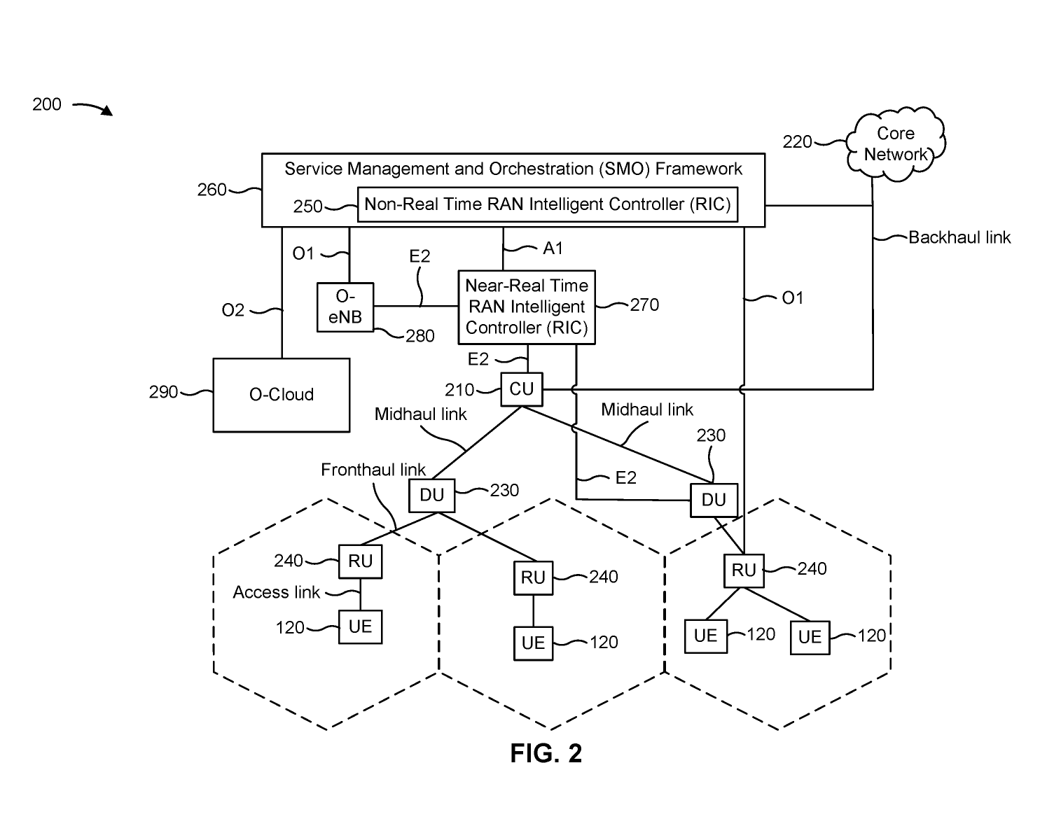

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into BWPs. A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a CSI reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, an L1 reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique, which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

In some aspects, a UE (e.g., the UE 120) may include a communication manager 150. As described in more detail elsewhere herein, the communication manager 150 may transmit, via capability signaling, an indication of one or more UE features associated with L1 CLI measurement and reporting; receive, based at least in part on the capability signaling, a configuration that indicates an L1 CLI resource for the L1 CLI measurement and a configuration for CLI reporting; and transmit a CLI report based at least in part on the configuration for CLI reporting, wherein the CLI report indicates an aperiodic CLI measurement associated with the L1 CLI resource. Additionally, or alternatively, the communication manager 150 may perform one or more other operations described herein.

In some aspects, a network node (e.g., the network node 110) may include a communication manager 155. As described in more detail elsewhere herein, the communication manager 155 may receive, via capability signaling, an indication of one or more UE features associated with L1 CLI measurement and reporting; transmit, based at least in part on the capability signaling, a configuration that indicates an L1 CLI resource for the L1 CLI measurement and a configuration for CLI reporting; and receive a CLI report based at least in part on the configuration for CLI reporting, wherein the CLI report indicates an aperiodic CLI measurement associated with the L1 CLI resource. Additionally, or alternatively, the communication manager 155 may perform one or more other operations described herein.

As indicated above, FIG. 1 is provided as an example. Other examples may differ from what is described with regard to FIG. 1.

FIG. 2 is a diagram illustrating an example disaggregated network node architecture 200, in accordance with the present disclosure. One or more components of the example disaggregated network node architecture 200 may be, may include, or may be included in one or more network nodes (such as one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs230 may communicate with one or more RUs240 via respective fronthaul links. Each of the RUs240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT

RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

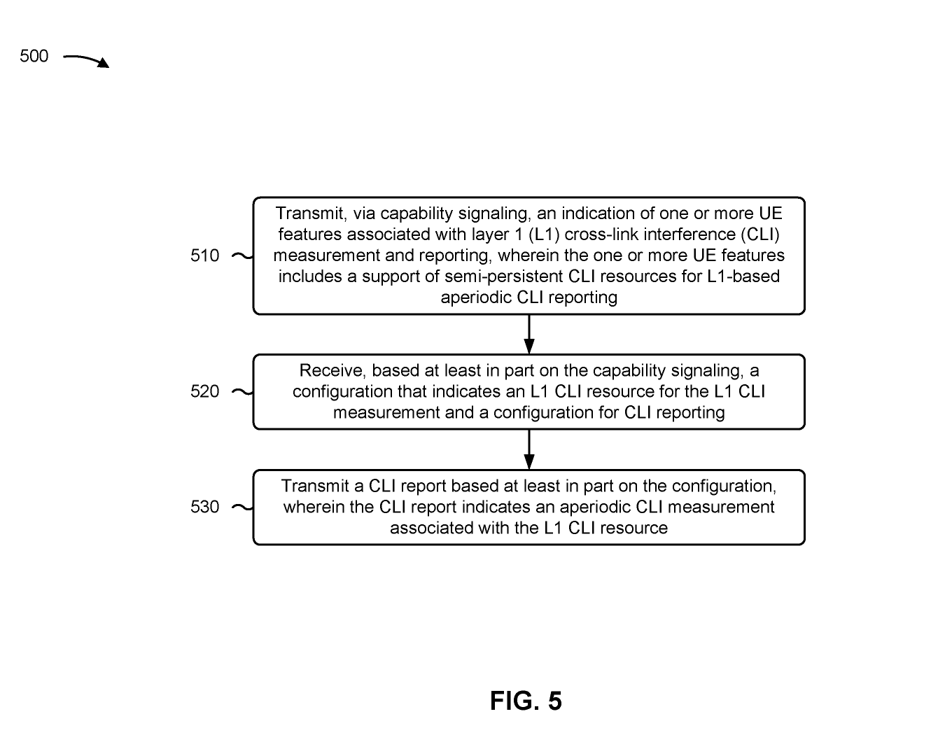

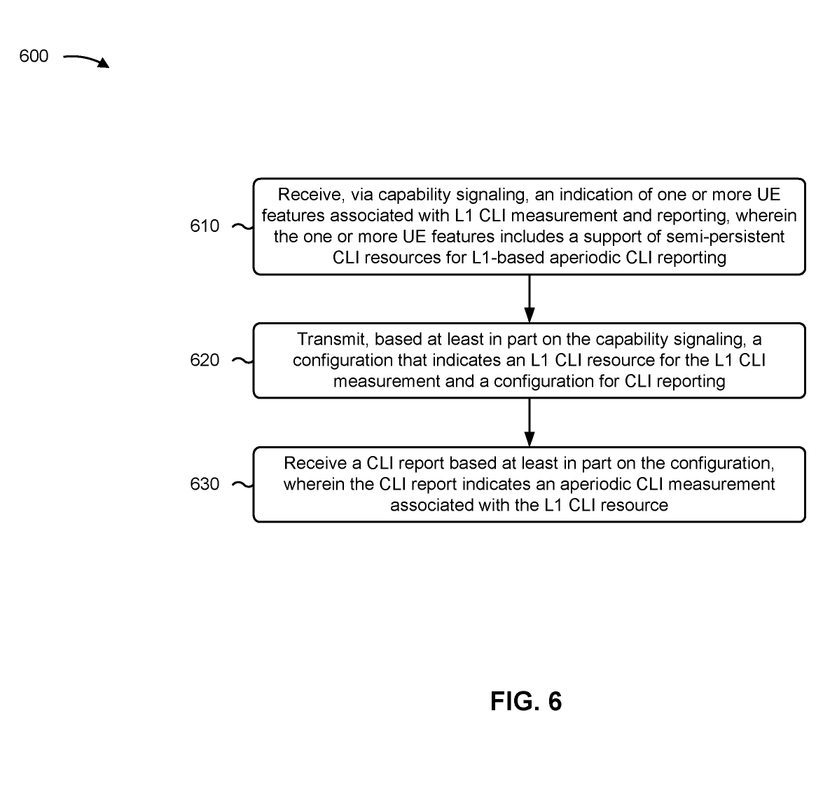

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with indicating UE features associated with CLI measurement and reporting, as described in more detail elsewhere herein. For example, the processing system 145 of the network node 110, the processing system 140 of the UE 120, the CU 210, the DU 230, or the RU 240 may perform or direct operations of, for example, process 500 of FIG. 5, process 600 of FIG. 6, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 500 of FIG. 5, process 600 of FIG. 6, or other processes as described herein. In some examples, executing instructions may include running the instructions, converting the instructions, compiling the instructions, and/or interpreting the instructions, among other examples.

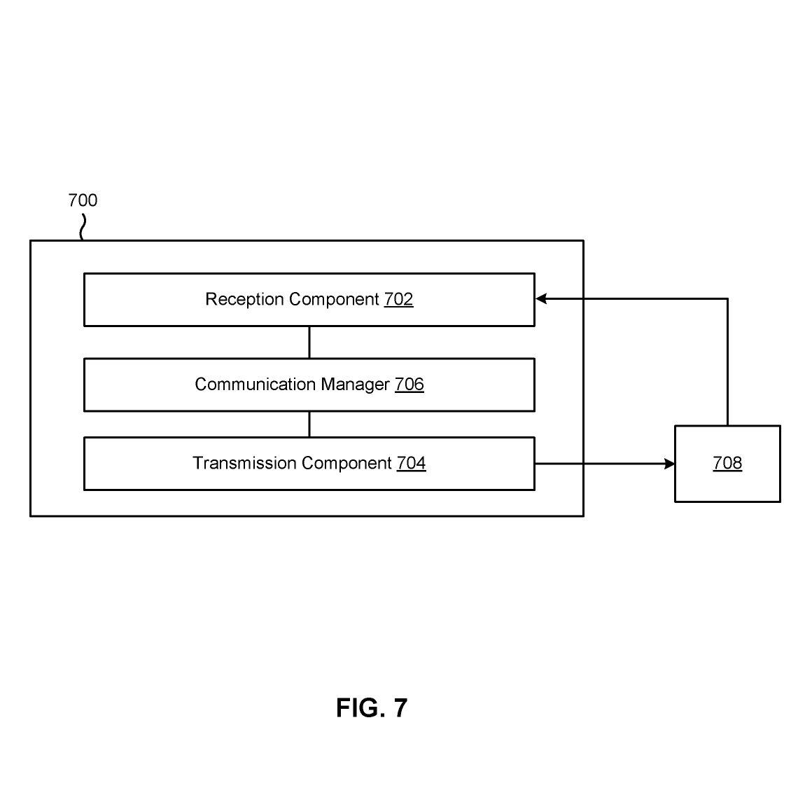

In some aspects, a UE (e.g., the UE 120) includes means for transmitting, via capability signaling, an indication of one or more UE features associated with L1 CLI measurement and reporting; means for receiving, based at least in part on the capability signaling, a configuration that indicates an L1 CLI resource for the L1 CLI measurement and a configuration for CLI reporting; and/or means for transmitting a CLI report based at least in part on the configuration for CLI reporting, wherein the CLI report indicates an aperiodic CLI measurement associated with the L1 CLI resource. The means for the UE to perform operations described herein may include, for example, one or more of communication manager 150, processing system 140, a radio, one or more RF chains, one or more transceivers, one or more antennas, one or more modems, a reception component (for example, reception component 702 depicted and described in connection with FIG. 7), and/or a transmission component (for example, transmission component 704 depicted and described in connection with FIG. 7), among other examples.

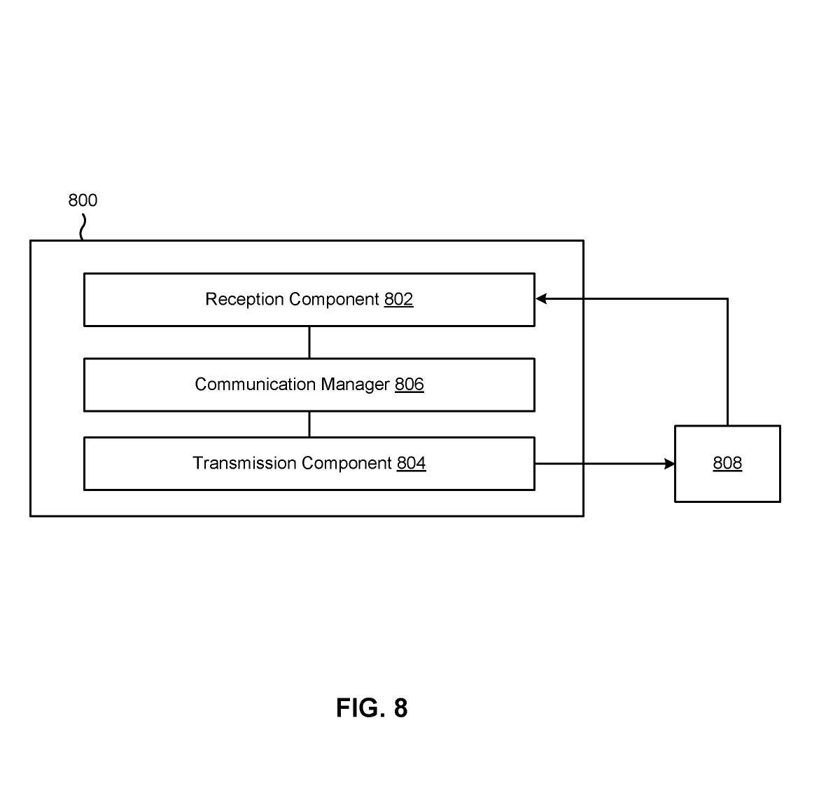

In some aspects, a network node (e.g., the network node 110) includes means for receiving, via capability signaling, an indication of one or more UE features associated with L1 CLI measurement and reporting; means for transmitting, based at least in part on the capability signaling, a configuration that indicates an L1 CLI resource for the L1 CLI measurement and a configuration for CLI reporting; and/or means for receiving a CLI report based at least in part on the configuration for CLI reporting, wherein the CLI report indicates an aperiodic CLI measurement associated with the L1 CLI resource. The means for the network node to perform operations described herein may include, for example, one or more of communication manager 155, processing system 145, a radio, one or more RF chains, one or more transceivers, one or more antennas, one or more modems, a reception component (for example, reception component 802 depicted and described in connection with FIG. 8), and/or a transmission component (for example, transmission component 804 depicted and described in connection with FIG. 8), among other examples.

As indicated above, FIG. 2 is provided as an example. Other examples may differ from what is described with regard to FIG. 2.

A CLI handling may involve a layer 1 (L1) based UE-to-UE CLI measurement and reporting, which may be based at least in part on a CSI framework. The L1 based UE-to-UE CLI measurement and reporting may be based at least in part on a periodic, semi-persistent, or aperiodic measurement resource (set) (e.g., SRS-RSRP resources or CLI-RSSI resources), and a configuration/determination of “typed” QCL assumptions for a CLI measurement resource. The L1 based UE-to-UE CLI measurement and reporting may be based at least in part on an aperiodic reporting, new report quantities (e.g., L1 SRS-RSRP, L1 CLI-RSSI, and/or measurement resource indices), uplink control information (UCI) bits generation, priority rules for multiple CSI reporting, and/or CLI measurement accuracy requirements. The L1 based UE-to-UE CLI measurement and reporting may be without a dedicated optimization for dynamic or flexible time division duplexing (TDD).

For the L1 based UE-to-UE CLI measurement and reporting, measurement resources for SRS-RSRP may be based at least in part on existing legacy reference signal (RS) patterns (e.g., no specification impact for SRS configuration information exchange between network nodes). Periodic and semi-persistent reporting may be considered in addition to aperiodic reporting. A wideband reporting may be supported for the new report quantities. An existing CSI processing unit, CPU occupation rule, and timeline for L1 beam reporting are reused for L1 UE-to-UE CLI measurement and reporting as a starting point.

A UE may report, to a network node, one or more UE features via one or more UE capability fields. A feature may be associated with an index, a feature group, one or more components, one or more prerequisites, one or more field names, one or more parent information elements (IEs), a need for frequency division duplexing (FDD) or TDD differentiation, a need for FR1 or FR2 differentiation, additional notes, and/or an indication of mandatory or optional signaling.

In one example, the feature may be MIMO. The index may be 2-33. The feature group may be CSI-RS and CSI-IM reception for CSI feedback. The one or more components may include a supported maximum number of configured NZP-CSI-RS resources per CC, a supported maximum number of ports across all configured NZP-CSI-RS resources per CC, a supported maximum number of configured CSI-IM resources per CC, a supported maximum number of simultaneous NZP-CSI-RS resources in active BWPs across all CCs, a supported maximum number of simultaneous NZP-CSI-RS resources per CC, a supported maximum total number of CSI-RS ports in simultaneous NZP-CSI-RS resources in active BWPs across all CCs, and a supported maximum total number of CSI-RS ports in simultaneous NZP-CSI-RS resources per CC. The one or more prerequisites may include index 2-32. The one or more field names may include maxConfigNumberNZP-CSI-RS-PerCC, maxConfigNumberPortsAcrossNZP-CSI-RS-PerCC, maxConfigNumberCSI-IM-PerCC, maxNumberSimultaneousNZP-CSI-RS-ActBWP-AllCC, maxNumberSimultaneousNZP-CSI-RS-PerCC, totalNumberPortsSimultaneousNZP-CSI-RS-ActBWP-AllCC, and totalNumberPortsSimultaneousNZP-CSI-RS-PerCC, which may correspond to the one or more components. The one or more parent IEs may include MIMO parameters per band (MIMO-ParametersPerBand).

In one example, the feature may be MIMO. The index may be 2-33b. The feature group may be semi-persistent (SP) CSI-RS. The one or more components may include a support for SP CSI-RS. The one or more prerequisites may include index 2-1. The one or more field names may include sp-CSI-RS, which may correspond to the one or more components.

In one example, the feature may be MIMO. The index may be 2-33c. The feature group may be SP CSI-IM. The one or more components may include a support for SP CSI-IM. The one or more prerequisites may include index 2-1. The one or more field names may include sp-CSI-IM, which may correspond to the one or more components.

In one example, the feature may be MIMO. The index may be 2-34. The feature group may be NZP-CSI-RS based interference measurement. The one or more components may include a support for NZP-CSI-RS based interference measurement. The one or more prerequisites may include index 2-33. The one or more field names may include nzp-CSI-RS-IntefMgmt, which may correspond to the one or more components.

In one example, the feature may be MIMO. The index may be 2-35. The feature group may be a CSI report framework. The one or more components may include a maximum number of periodic CSI report settings per BWP for a CSI report, a maximum number of periodic CSI report settings per BWP for a beam report, a maximum number of aperiodic CSI report settings per BWP for a CSI report, a maximum number of aperiodic CSI report settings per BWP for a beam report, a maximum number of configured aperiodic CSI triggering states in a CSI aperiodic trigger state list (CSI-AperiodicTriggerStateList) per CC, a maximum number of semi-persistent CSI report settings per BWP for a CSI report, a maximum number of semi-persistent CSI report settings per BWP for a beam report, an indication that the UE is able to process a defined number of CSI reports simultaneously in a CC (e.g., CSI reports may be periodic, semi-persistent, or aperiodic CSI and any latency class and codebook type), and/or an indication that the UE is able to process a defined number of CSI reports simultaneously across all CCs (e.g., CSI reports may be periodic, semi-persistent, or aperiodic CSI and any latency class and codebook type). The one or more prerequisites may include index 2-32. The one or more field names may include maxNumberPeriodicCSI-PerBWP-ForCSI-Report, maxNumberPeriodicCSI-PerBWP-ForBeamReport, maxNumberAperiodicCSI-PerBWP-ForCSI-Report, maxNumberAperiodicCSI-PerBWP-ForBeamReport, maxNumberAperiodicCSI-triggeringStatePerCC, maxNumberSemiPersistentCSI-PerBWP-ForCSI-Report, and maxNumberSemiPersistentCSI-PerBWP-ForBeamReport, which may correspond to the one or more components. The one or more parent IEs may include MIMO parameters per band (MIMO-ParametersPerBand). In this example, other MIMO capabilities may further restrict (e.g., reduce) a number of simultaneous CSI reports that the UE is required to update. A CSI report may include a beam report and a CSI report in some cases. Each component of the one or more components may be independent of another component. A CSI report setting may be counted in a CC indicated by a parameter carrier in a CSI resource configuration (CSI-ResourceConfig).

In one example, the feature may be NR CLI remote interference management (RIM). The index may be 17-1. The feature group may be CLI-RSSI measurement. The one or more components may include a support for CLI-RSSI measurement (e.g., a maximum number of resources across all CCs configured to measure RSSI may not exceed 64) and a maximum number of measurement resources configured for CLI-RSSI measurement. The one or more field names may include cli-RSSI-Meas-r16 and maxNumberCLI-RSSI-r16, which may correspond to the one or more components. In this example, the maximum number of measurement resources configured for CLI-RSSI measurement may be 8, 16, 32, or 64. CLI measurement may not be supported in unlicensed bands.

In one example, the feature may be NR CLI RIM. The index may be 17-2. The feature group may be SRS-RSRP measurement. The one or more components may include a support for SRS-RSRP measurement (e.g., a maximum number of SRS resources across all CCs configured to measure SRS-RSRP may not exceed 32), a maximum number of measurement resources across all CCs configured for SRS-RSRP measurement, and a maximum number of measurement resources across all CCs configured for SRS-RSRP measurement within a slot. The slot may be based at least in part on a minimum SCS among active BWPs across all CCs configured for SRS-RSRP measurement. An SRS resource occasion that overlaps with the slot may be counted as one measurement resource in the slot. The one or more field names may include cli-SRS-RSRP-Meas-r16, maxNumberCLI-SRS-RSRP-r16, and maxNumberPerSlotCLI-SRS-RSRP-r16, which may correspond to the one or more components. In this example, the maximum number of measurement resources across all CCs configured for SRS-RSRP measurement may be 4, 8, 16, or 32. The maximum number of measurement resources across all CCs configured for SRS-RSRP measurement within the slot may be 2, 4, or 8. CLI measurement may not be supported in unlicensed bands.

In one example, the feature may be NR CLI RIM. The index may be 17-3. The feature group may be simultaneous reception of downlink signals/channels and CLI-RSSI measurement resources. The one or more components may include a support for simultaneous reception of downlink signals/channels and CLI-RSSI measurement resources. The one or more prerequisites may include index 17-1. The one or more field names may include cli-RSSI-FDM-DL-r16, which may correspond to the one or more components. The UE may prioritize CLI-RSSI measurements when simultaneous reception of downlink signals/channels and CLI-RSSI measurement resources are not supported.

In one example, the feature may be NR CLI RIM. The index may be 17-4. The feature group may be simultaneous reception of downlink signals/channels and SRS-RSRP measurement resources. The one or more components may include a support for simultaneous reception of downlink signals/channels and SRS-RSRP measurement resources. The one or more prerequisites may include index 17-2. The one or more field names may include cli-SRS-RSRP-FDM-DL-r16, which may correspond to the one or more components. The UE may prioritize SRS-RSRP measurements when simultaneous reception of downlink signals/channels and SRS-RSRP measurement resources is not supported.

UE features may include UE features for AI/ML for an NR air interface, UE features for NR MIMO, and/or UE features for an NR duplex operation, such as SBFD.

In a wireless communications network, a UE may not be configured to report one or more UE features related to L1 CLI measurements and reporting. The one or more UE features used to indicate the UE capabilities may not include UE features related to L1 CLI measurements and reporting. The UE may be unable to appropriately perform L1 CLI measurements and report the L1 CLI measurements to the network node, which may prevent the network node from mitigating CLI. Further, the one or more UE features may not include UE features related to counting CLI reports in relation to CSI reports that are already reported by the UE to the network node. The UE may be limited in a number of CSI reports that are able to be measured and processed simultaneously in a CC, and the UE may not be configured to handle both CSI reports not including CLI reports and CSI reports that include CLI reports. Without suitable UE capability reporting by the UE to the network node, the CLI may not be properly mitigated, which may degrade an overall system performance. The UE may have specific capabilities for which CLI quantities (e.g., RSSI or SRS-RSRP) that are able to be measured and reported. In addition, the UE may have specific capabilities to receive and measure one or more CLI-RSSI resources in a downlink subband of an SBFD symbol, CLI-RSSI resources within an uplink subband, and/or a CLI-SRS-RSRP in an uplink subband.

In various aspects of techniques and apparatuses described herein, a UE may transmit, to the network node via capability signaling, an indication of one or more UE features associated with L1 CLI measurement and reporting. The capability signaling may indicate a number of CSI reports for which the UE is able to measure and process reference signals simultaneously in a CC, where a CSI report may include a CLI report. Alternatively, capability signaling may indicate a number of CSI reports for which the UE is able to measure and process CLI resources simultaneously in a CC, where the CSI report may include the CLI report. The CLI report may be counted based at least in part on the capability signaling. The one or more features may include a support of aperiodic CLI reporting associated with aperiodic CLI resources. The one or more features may include a CLI report quantity. The one or more features may include a maximum number of aperiodic CSI report settings per BWP for the CLI report. The one or more features may include a maximum number of CLI reports for which the UE is able to measure and process CLI resources simultaneously in a CC. The one or more features may include a maximum number of CLI reports for which the UE is able to measure and process CLI resources simultaneously across one or more CCs. The UE may receive, from the network node and based at least in part on the capability signaling, a configuration that indicates an L1 CLI resource for the L1 CLI measurement and a configuration for CLI reporting. The UE may transmit, to the network node, the CLI report based at least in part on the configuration, where the CLI report may indicate an aperiodic CLI measurement associated with the L1 CLI resource.

In some examples, by configuring the UE to report one or more UE features associated with L1 CLI measurement and reporting, the UE may be able to receive a configuration based at least in part on the one or more UE features and transmit a CLI report based at least in part on the configuration for CLI reporting. The configuration, which may indicate the L1 CLI resource, may depend on the one or more UE features indicated in the capability signaling. The CLI report that indicates the aperiodic CLI measurement associated with the L1 CLI resource may be in accordance with the configuration. By configuring the capability signaling to indicate the number of CSI reports for which the UE is able to measure and process simultaneously, the UE may be able to maximize a number of CSI reports that are simultaneously processed, where the CSI reports may include L1 CLI measurements and non-L1-CLI measurements. By configuring the UE to appropriately measure and report L1 CLI, the network node may be able to perform suitable actions to mitigate the CLI, thereby improving an overall system performance.

In some aspects, the UE may indicate, to the network node via RRC signaling, basic UE feature groups for L1 CLI resources and/or additional UE feature groups for L1 CLI resources. The UE may receive a configuration from the network node, where the configuration may be based at least in part on the basic UE feature groups for L1 CLI resources and/or the additional UE feature groups for L1 CLI resources. The configuration may be associated with CLI reporting and/or CLI resources, where the CLI reporting and/or the CLI resources may be aligned with a UE capability indicated by the basic UE feature groups for L1 CLI resources and/or the additional UE feature groups for L1 CLI resources. The UE may measure an aperiodic CLI resource and perform a counting of CLI resources and/or CLI reports in accordance with the configuration. The UE may report the aperiodic CLI to the network node, where the network node may perform one or more actions based at least in part on the aperiodic CLI.

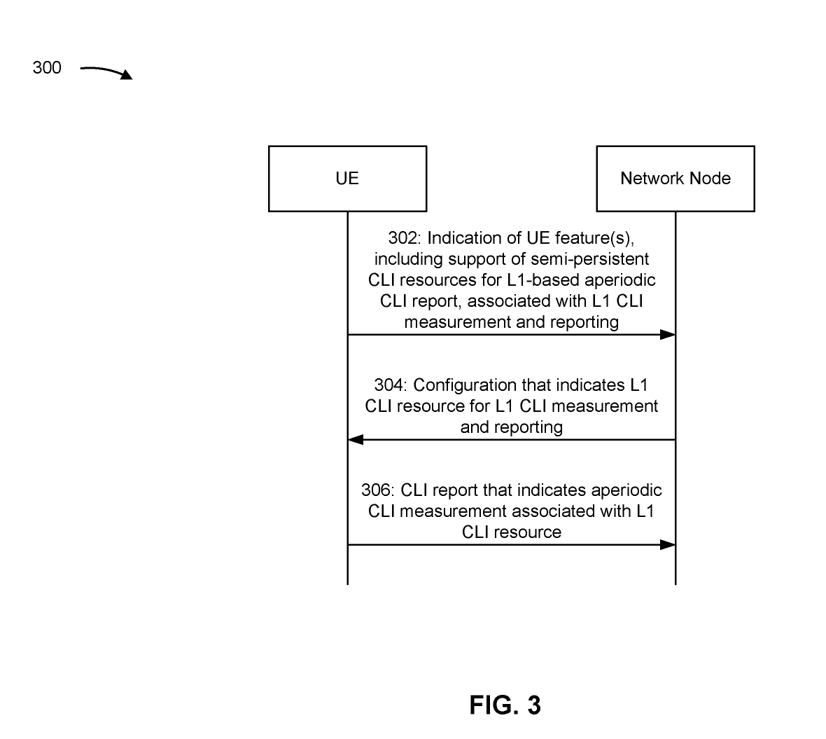

FIG. 3 is a diagram illustrating an example 300 associated with indicating UE features associated with CLI measurement and reporting, in accordance with the present disclosure. As shown in FIG. 3, example 300 includes communication between a UE (e.g., UE 120) and a network node (e.g., network node 110). In some aspects, the UE and the network node may be included in a wireless network, such as wireless network 100.

As shown by reference number 302, the UE may transmit, to the network node via capability signaling, an indication of one or more UE features associated with L1 CLI measurement and reporting, where the one or more UE features may include a support of semi-persistent CLI resources for L1-based aperiodic CLI reporting. The UE may support using the semi-persistent CLI resources in order to perform the L1-based aperiodic CLI reporting. The UE may transmit the indication via RRC signaling. The one or more UE features may include or be associated with basic UE features (or feature groups) and/or additional UE features (or feature groups). The one or more UE features may be related to the CLI measurement and reporting. The capability signaling may include one or more fields to indicate the one or more UE features associated with L1 CLI measurement and reporting. A counting of a CLI report may be in accordance with the capability signaling, and a counting of L1 CLI resources may be in accordance with the capability signaling. The UE may be configured with a configuration based at least in part on the capability signaling, where the configuration may indicate an L1 CLI resource for the L1 CLI measurement and reporting. The configuration may be used to transmit the CLI report, where the CLI report may indicate an aperiodic CLI reporting associated with the L1 aperiodic CLI resource.

In some aspects, the one or more UE features may include a support of aperiodic CLI reporting associated with aperiodic CLI resources, and/or a CLI report quantity, where the CLI report quantity may be associated with a CLI-RSSI and/or a CLI-SRS-RSRP. The aperiodic CLI resources may include CLI-RSSI resources and/or CLI-SRS-RSRP resources. In some aspects, the one or more UE features may include a support of aperiodic CLI reporting associated with aperiodic, semi-persistent, and/or periodic CLI resources, where the CLI resources may include CLI-RSSI resources or CLI-SRS-RSRP resources, and/or a CLI report quantity.

In some aspects, basic UE features may be defined for L1-based CLI measurement and reporting. The basic UE features may be associated with aperiodic CLI reporting and periodic, semi-persistent, and/or aperiodic CLI resources and report quantities.

In some aspects, a basic UE feature for L1-based CLI measurements and reporting may include one or more components. The one or more components may include a support of aperiodic CLI reporting using aperiodic CLI resources. The one or more components may include a CLI report quantity (e.g., CLI-RSSI and/or CLI-SRS-RSRP) using a bitmap with at least one quantity reported. A support of aperiodic CLI reporting using periodic or semi-persistent CLI-RSSI or SRS-RSRP resources may be a separate UE capability.

In some aspects, a basic UE feature for L1-based CLI measurements and reporting may include one or more components. The one or more components may include a support of aperiodic CLI reporting using aperiodic, semi-persistent, or periodic CLI-RSSI resources or aperiodic, semi-persistent, or periodic SRS-RSRP resources. The one or more components may include a CLI report quantity (e.g., CLI-RSSI and/or CLI-SRS-RSRP) using a bitmap with at least one quantity reported. In some respects where CLI measurements are performed in SBFD symbols, the CLI report quantity may be associated with a CLI-RSSI in a downlink subband, a CLI-SRS-RSRP in an uplink subband, and/or a CLI-RSSI in an uplink subband. The UE may report which CLI quantities (e.g., via a bitmap) are supported.

In some aspects, the one or more UE features may include a support of aperiodic CLI reporting associated with periodic, semi-persistent, and/or aperiodic CLI resources, a CLI report quantity, and/or a maximum number of aperiodic CSI report settings per BWP for the CLI report. In some aspects, the capability signaling may indicate a number of CSI reports for which the UE is able to measure and process reference signals simultaneously in a CC, where the CSI report may include a CLI report. The CLI report may be counted based at least in part on the capability signaling.

In some aspects, a basic UE feature for L1-based CLI measurements and reporting may include one or more components. The one or more components may include a support of aperiodic CLI reporting using periodic, semi-persistent, or aperiodic CLI resources. The one or more components may include a CLI report quantity (e.g., CLI-RSSI and/or CLI-SRS-RSRP) using a bitmap with at least one quantity reported. The one or more components may be associated with an aperiodic reporting capability, where the one or more components may include a maximum number of aperiodic CSI report settings per BWP for a CLI report.

In some aspects, for the basic UE feature for L1-based CLI measurements and reporting, a joint counting of CLI reports and CSI reports may be toward one quantity of a simultaneous CSI reports per CC (simultaneousCSI-ReportsPerCC). The simultaneous CSI reports per CC may indicate a number of CLI reports for which the UE can measure and process reference signals simultaneously in a CC of a band for which such a capability is provided. A CSI report may include periodic, semi-persistent, and/or aperiodic CSI, and the CSI report may include any latency classes and codebook types. A CSI report associated with the simultaneous CSI reports per CC may include a beam report, a CLI report, and a CSI report.

In some aspects, the one or more UE features may include a support of aperiodic CLI reporting associated with periodic, semi-persistent, and/or aperiodic CLI resources, a CLI report quantity, a maximum number of aperiodic CSI report settings per BWP for the CLI report, a maximum number of CLI reports for which the UE is able to measure and process CLI resources simultaneously in a CC, and/or a maximum number of CLI reports for which the UE is able to measure and process CLI resources simultaneously across one or more CCs. In some aspects, the capability signaling may indicate a number of CSI reports for which the UE is able to measure and process CLI resources simultaneously in a CC, where a CSI report may include the CLI report. The CLI report may be counted based at least in part on the capability signaling.

In some aspects, a basic UE feature for L1-based CLI measurements and reporting may include one or more components. The one or more components may include a support of aperiodic CLI reporting using periodic, semi-persistent, or aperiodic CLI-RSSI resources. The one or more components may include a CLI report quantity (e.g., CLI-RSSI and/or CLI-SRS-RSRP) using a bitmap with at least one quantity reported. The one or more components may be associated with an aperiodic CLI-RSSI reporting capability, where the one or more components may include a maximum number of aperiodic CSI report settings per BWP for a CLI-RSSI report, a maximum number of CLI reports simultaneously in a CC, and/or a maximum number of CLI reports simultaneously across all CCs.

In some aspects, for the basic UE feature for L1-based CLI measurements and reporting, a separate counting of CLI reports may be toward a quantity associated with simultaneous CLI reports per CC (simultaneousCLI-ReportsPerCC), which may be separate from a simultaneous CSI reports per CC (simultaneousCSI-ReportsPerCC). The simultaneous CLI reports per CC may indicate a number of CLI reports for which the UE can measure and process CLI resources simultaneously in a CC of a band for which such a capability is provided. A CLI report may include aperiodic CLI reports for CLI-RSSI and SRS-RSRP.

In some aspects, the one or more UE features may include a support of aperiodic CLI reporting associated with periodic, semi-persistent, and/or aperiodic CLI resources, a CLI report quantity, a maximum number of aperiodic CSI report settings per BWP for the CLI report, a maximum number of CLI reports for which the UE is able to measure and process CLI resources simultaneously in a CC, a maximum number of CLI reports for which the UE is able to measure and process CLI resources simultaneously across one or more CCs, a maximum number of configured CLI measurement resources per CC or per BWP, a maximum number of configured CLI measurement resources across the one or more CCs, a maximum number of simultaneous CLI resources per CC, a maximum number of simultaneous CLI resources

in active BWPs across the one or more CCs, a maximum number of measured CLI resources per slot per CC, and/or a maximum number of measured CLI resources per slot across the one or more CCs. In some aspects, the UE may report different quantities of a maximum number of configured CLI-RSSI resources and a maximum number of configured CLI-SRS-RSRP resources per-BWP, per-CC, and across CCs. In some aspects, the capability signaling may indicate a maximum number of active or simultaneous CLI resources per CC or across one or more CCs, and a maximum number of NZP-CSI-RS resources. The capability signaling may indicate a shared counting for active or simultaneous CLI resources per CC or across one or more CCs and NZP-CSI-RS resources. In other aspects, a counting of active simultaneous CLI resources may be based at least in part on a separate counting of CLI resources and CLI-SRS-RSRP resources. The counting of CLI resources may be based at least in part on a joint counting of CLI-RSSI resources and CLI-SRS-RSRP resources or a separate counting of CLI-RSSI resources and CLI-SRS-RSRP resources.

In some aspects, a basic UE feature for L1-based CLI measurements and reporting may include one or more components. The one or more components may include a support of aperiodic CLI reporting using periodic, semi-persistent, or aperiodic CLI resources. The one or more components may include a CLI report quantity (e.g., CLI-RSSI and/or CLI-SRS-RSRP) using a bitmap with at least one quantity reported. The one or more components may be associated with an aperiodic reporting capability, where the one or more components may include a maximum number of aperiodic CSI report settings per BWP for a CLI report, a maximum number of CLI reports simultaneously in a CC, and/or a maximum number of CLI reports simultaneously across all CCs. The one or more components may be associated with a resources capability, where the one or more components may include a maximum number of configured CLI measurement resources per CC (or per BWP), a maximum number of configured CLI measurement resources across all CCs, a maximum number of simultaneous CLI resources per CC, a maximum number of simultaneous CLI resources in active BWPs across all CCs, a maximum number of measured CLI resources per slot per CC, and/or a maximum number of measured CLI resource per slot across all CCs

In some aspects, a CLI resource capability may involve a separate counting of active simultaneous CLI resources per CC or across CCs. Regarding the maximum number of simultaneous CLI resources per CC and the maximum number of

simultaneous CLI resources in active BWPs across all CCs, the UE may separately count active or simultaneous periodic, semi-persistent, and/or aperiodic CLI-RSSI resources from NZP-CSI-RS resources. A counting of CLI resources may be a separate counting of CLI-RSSI resources and CLI-SRS-RSRP resources, or both resource types may be counted toward one maximum of CLI resources.

In some aspects, the L1 CLI resource may be active for a duration of time. The duration of time may depend on whether the L1 CLI resource is an aperiodic CLI resource, a semi-persistent CLI resource, or a periodic CLI resource.

In some aspects, a timeline for active CLI resources may be defined. A CLI resource may be active in the duration of time, where the duration of time may be defined accordingly. The duration of time, for an aperiodic CLI-RSSI or CLI-SRS-RSRP resource, may start from an end of a PDCCH containing a request and end at an end of a PUSCH containing a report associated with the aperiodic CLI-RSSI or CLI-SRS-RSRP resource. The duration of time, for a semi-persistent CLI-RSSI or CLI-SRS-RSRP resource, may start from an end of when an activation command is applied, and end at an end of when a deactivation command is applied. The duration of time, for a periodic CLI-RSSI or CLI-SRS-RSRP resource, may start when a periodic CLI resource is configured by higher layer signaling, and end when a periodic CLI configuration is released. When a CLI-RSSI or CLI-SRS-RSRP resource is referred to by N CSI reporting settings, the CLI-RSSI or CLI-SRS-RSRP resource may be counted N times, where N is a positive integer.

In some aspects, the capability signaling may indicate a maximum number that includes: a number of active or simultaneous CLI resources per CC or across one or more CCs, and a number of NZP-CSI-RS resources. The capability signaling may indicate a separate counting for active or simultaneous CLI resources per CC or across one or more CCs and NZP-CSI-RS resources.

In some aspects, a basic UE feature for L1-based CLI measurements and reporting may include one or more components. The one or more components may include a support of aperiodic CLI reporting using periodic, semi-persistent, or aperiodic CLI resources. The one or more components may include a CLI report quantity (e.g., CLI-RSSI and/or CLI-SRS-RSRP) using a bitmap with at least one quantity reported. The one or more components may be associated with an aperiodic reporting capability, where the one or more components may include a maximum number of aperiodic CSI report settings per BWP for a CLI report, a maximum number

of CLI reports simultaneously in a CC, and/or a maximum number of CLI reports simultaneously across all CCs. The one or more components may be associated with a resources capability, where the one or more components may include a maximum number of configured CLI measurement resources per CC (or per BWP), a maximum number of configured CLI measurement resources across all CCs, a maximum number of measured CLI resources per slot per CC, and/or a maximum number of measured CLI resource per slot across all CCs.

In some aspects, a CLI resource capability may involve a same counting of active simultaneous CLI and CSI resources per CC or across CCs. A counting of CLI resources may be a separate counting of CLI-RSSI resources and CLI-SRS-RSRP resources, or both resource types may be counted toward one maximum of CLI resources.

In some aspects, the one or more UE features may include a support of periodic CLI resources for L1-based aperiodic CLI reporting, and/or a support of semi-persistent CLI resources for L1-based aperiodic CLI reporting. In some aspects, the one or more UE features are associated with a frequency division multiplexing (FDM) of a downlink signal or channel reception and CLI measurements. The one or more UE features may include a simultaneous reception of downlink signals or channels in a downlink sub-band and an L1 CLI measurement resource in an uplink sub-band, and/or a simultaneous reception of downlink signals or channels in a first downlink sub-band and an L1 CLI measurement resource in a second downlink sub-band.

In some aspects, additional UE feature groups for L1 CLI measurement and reporting may be defined. The additional UE features may include support of periodic CLI measurement resources for L1-based aperiodic CLI reporting, and/or support of semi-persistent CLI measurement resources for L1-based aperiodic CLI reporting.

In some aspects, an FDM of downlink signals/channel reception and CLI measurements may be an additional UE feature where the UE may simultaneously receive the downlink signal/channel from the network node and measure the CLI in different frequency resources. The additional UE feature may include simultaneous reception of downlink signals/channels in a downlink sub-band and L1 CLI-SRS-RSRP measurement resources in an uplink sub-band, simultaneous reception of downlink signals/channels in a downlink sub-band and L1 CLI-RSSI measurement resources in an uplink sub-band, and/or simultaneous reception of downlink signals/channels in a downlink sub-band and L1 CLI-RSSI measurement resources in a downlink sub-band.

Different FDM capabilities may be based at least in part on a CLI quantity and whether the UE utilizes a downlink timing or an uplink timing for the CLI measurements.

In some aspects, the one or more UE features may include a support of L1 CLI reporting and a support of layer 3 (L3) CLI reporting, where L1 CLI resources may not be configured simultaneously with L3 CLI resources. When the UE supports both L1 CLI reporting in addition to L3 CLI reporting, the UE may not expect to be configured simultaneously with L1 resources and L3 CLI resources unless the UE supports an additional feature for simultaneous configuration of L1-CLI resources and L3 CLI resources. In some aspects, the one or more UE features may include a support of L1 CLI reporting and a support of L3 CLI reporting, where L1 CLI resources may be configured simultaneously with L3 CLI resources based at least in part on a UE capability. In some aspects, the one or more UE features may include a support of a simultaneous configuration of L1 CLI resources and L3 CLI resources, where a counting of a maximum number of configured L1 CLI resources may be separate from a counting of a maximum number of configured L3 CLI resources. In some aspects, the one or more UE features may include a support of a simultaneous configuration of L1 CLI resources and L3 CLI resources, where the L1 CLI resources and the L3 CLI resources may be both counted toward a same reported capability of a maximum number of CLI resources.

In some aspects, the UE may support both L1 CLI reporting and L3 CLI reporting (e.g., both L3 CLI-RSSI and L1 CLI-RSSI measurement and reporting). In some aspects, the UE may not expect to be configured simultaneously with L1 and L3 CLI resources, such that the UE may only be configured with L1 CLI resources or L3 CLI resources at a given time. In some aspects, the UE may be simultaneously configured with L1 CLI resources and L3 CLI resources based at least in part on a UE capability.

In some aspects, the UE may indicate, to the network node, a capability to support a simultaneous configuration of L1 CLI resources and L3 CLI resources. In some aspects, a counting of a maximum number of configured L1 CLI-RSSI (or CLI-SRS-RSRP) measurement resources and a counting of a maximum number of configured L3 CLI-RSSI measurement resources (or CLI-SRS-RSRP) may be done separately. For example, the UE may report capabilities for a maximum number of configured resources independently. In some aspects, both L1 CLI resources and L3 CLI resource may be counted toward a same reported capability of a maximum number of CLI resources. A reported capability of a maximum number of CLI resources may correspond to a maximum number of CLI-SRS-RSRP (maxNumberCLI-SRS-RSRP-r16) or a maximum number of CLI-RSSI (maxNumberCLI-RSSI-r16). The reported capability of a maximum number of CLI resources may correspond to a maximum configured number of CLI-RSSI per CC (maxConfigNumberCLI-RSSI-PerCC) or a maximum configured number of CLI-SRS-RSRP per CC (maxConfigNumberCLI-SRS-RSRP-PerCC). The reported capability of a maximum number of CLI resources may correspond to a minimum or a maximum of maxNumberCLI-SRS-RSRP-r16, maxNumberCLI-RSSI-r16, maxConfigNumberCLI-RSSI-PerCC, and maxConfigNumberCLI-SRS-RSRP-PerCC.

In some aspects, a UE features list may be defined for an NR duplex evolution. A feature may be associated with an index, a feature group, one or more components, one or more prerequisite feature groups, an indication of whether the network node is to have information regarding whether the feature group is supported, an indication of whether the feature group is applicable to a capability signaling exchange between UEs (sidelink), a consequence of the feature group not being supported by the UE, a type (e.g., a type for UE features may be based at least in part on a granularity of per UE, per band, per band combination, per frequency spectrum, or per feature set per component carrier (FSPC)), an indication of a need for FDD or TDD differentiation, an indication of a need for FR1 or FR2 differentiation, a capability interpretation for a mixture of FDD/TDD and/or FR1/FR2, additional notes, and/or an indication of mandatory or optional signaling.

In some aspects, the feature may be NR duplex evolution. The index may be 60-4-1. The feature group may be L1 based CLI reporting. The one or more components may include a support of aperiodic CLI-RSSI reporting using aperiodic CLI-RSSI resources and/or a CLI report quantity of CLI-RSSI and CLI-SRS-RSRP. The one or more components may be associated with an aperiodic reporting capability, where the one or more components may include a maximum number of aperiodic CSI report settings per BWP for a CLI-RSSI report. The one or more prerequisite feature groups may include index 2-35 and index 2-32. The network node may have information indicating that the feature group is supported. When the feature group is not supported by the UE, L1 CLI-RSSI measurements and reporting may not be supported. The type may be per band. In some aspects, CLI reports may be counted toward a maximum number of CLI reports (e.g., simultaneousCSI-ReportsPerCC). The CLI report quantity of CLI-RSSI and CLI-SRS-RSRP may be associated with a bitmap of candidate values. At least one quantity may be reported. The maximum number of aperiodic CSI report settings per BWP for the CLI-RSSI report may be 1, 2, 3, or 4.

In some aspects, the feature may be NR duplex evolution. The index may be 60-4-1a. The feature group may be L1 based CLI -RSSI resources. The one or more components may include a CLI-RSSI resources capability, where the one or more components may include a maximum number of configured CLI measurement resources per CC (or per BWP), a maximum number of configured CLI measurement resources across all CCs, a maximum number of simultaneous CLI-RSSI resources per CC, a maximum number of simultaneous CLI-RSSI resources in active BWPs across all CCs, a maximum number of CLI measurement resources per slot per CC, and/or a maximum number of CLI measurement resources per slot across all CCs. The maximum number of configured CLI measurement resources per CC (or per BWP) may be from 1 to 32. The maximum number of configured CLI measurement resources across all CCs may be from 1 to 64. The maximum number of simultaneous CLI-RSSI resources per CC may be 3, 7, 15, 31, 63, or 128.

In some aspects, the feature may be NR duplex evolution. The index may be 60-4-1b. The feature group may be L1 based CLI-SRS-RSRP resources. The one or more components may include a CLI-SRS-RSRP resources capability, where the one or more components may include a maximum number of configured CLI measurement resources per CC (or per BWP), a maximum number of configured CLI measurement resources across all CCs, a maximum number of simultaneous CLI-SRS-RSRP resources per CC, a maximum number of simultaneous CLI-SRS-RSRP resources in active BWPs across all CCs, a maximum number of CLI-SRS-RSRP measurements resource per slot per CC, and/or a maximum number of CLI-SRS-RSRP measurement resources per slot across all CCs.

In some aspects, the feature may be NR duplex evolution. The index may be 60-4-1c. The feature group may be periodic CLI-RSSI resources. The one or more components may include a support of periodic CLI resources for L1-based aperiodic CLI reporting. The one or more prerequisite feature groups may include index 60-4-1. Candidate values may be a bitmap associated with CLI-RSSI resources and CLI-SRS-RSRP resources.

In some aspects, the feature may be NR duplex evolution. The index may be 60-4-1d. The feature group may be semi-persistent CLI-RSSI resources. The one or more components may include a support of semi-persistent for L1-based aperiodic CLI reporting. The one or more prerequisite feature groups may include index 60-4-1. Candidate values may be a bitmap associated with CLI-RSSI resources and CLI-SRS-RSRP resources.

In some aspects, the feature may be NR duplex evolution. The index may be 60-4-1d. The feature group may be FDM downlink reception and L1 CLI-RSSI measurements. The one or more components may include a simultaneous reception of downlink signals/channels in a downlink sub-band and CLI-RSSI measurement resources in an uplink sub-band.

In some aspects, the feature may be NR duplex evolution. The index may be 60-4-1e. The feature group may be FDM downlink reception and L1 CLI-RSSI measurements. The one or more components may include a simultaneous reception of downlink signals/channels in a downlink sub-band and CLI-SRS-RSRP measurement resources in an uplink sub-band. The one or more prerequisite feature groups may include index 60-4-1.

In some aspects, the feature may be NR duplex evolution. The index may be 60-4-1f. The feature group may a support of a simultaneous configuration of L3 CLI-RSSI measurements and L1 CLI-RSSI measurements. The one or more components may include support of simultaneous configurations of L1 CLI-RSSI resources and L3 CLI-RSSI resources, and/or a same/separate counting of a maximum number of measurement resources configured for CLI-RSSI measurements. A number of resources corresponding to L3 resources and L1 resources may not exceed 32.

As shown by reference number 304, the UE may receive, from the network node and based at least in part on the capability signaling, the configuration that indicates the L1 CLI resource for the L1 CLI measurement and reporting. The configuration may indicate the plurality of L1 CLI resources. The plurality of L1 CLI resources may include L1 CLI-RSSI resources and/or L1 CLI-SRS-RSRP resources. A quantity associated with the plurality of L1 CLI resources may satisfy a maximum capability associated with the UE. In other words, the configuration may not indicate a quantity of L1 CLI resources that exceeds a capability of the UE.

As shown by reference number 306, the UE may transmit, to the network node, the CLI report based at least in part on the configuration. The CLI report may indicate the aperiodic CLI measurement associated with the L1 CLI resource. The UE may measure the plurality of L1 CLI resources, and then the UE may transmit the CLI report that indicates measured L1 CLI resources. The network node may receive the CLI report, and depending on the CLI report, the network node may perform one or more actions to reduce CLI associated with the UE.

As indicated above, FIG. 3 is provided as an example. Other examples may differ from what is described with regard to FIG. 3.

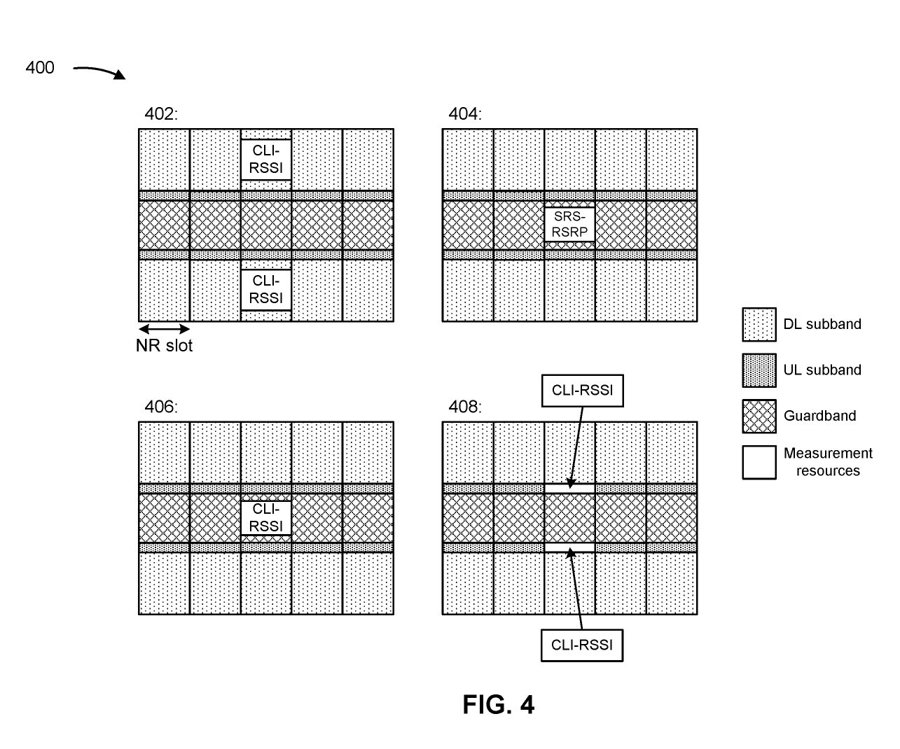

FIG. 4 is a diagram illustrating an example 400 associated with indicating UE features associated with CLI measurement and reporting, in accordance with the present disclosure.

As shown by reference number 402, as part of additional UE feature groups for L1 CLI measurement and reporting, a first CLI-RSSI measurement resource may be associated with a first downlink sub-band and a second CLI-RSSI measurement resource may be associated with a second downlink sub-band. The first downlink sub-band and the second downlink sub-band may be associated with a same NR slot (e.g., an SBFD slot). As shown by reference number 404, an SRS-RSRP measurement resource may be associated with an uplink sub-band of an NR slot (e.g., an SBFD slot). As shown by reference number 406, a CLI-RSSI measurement resource may be associated with an uplink sub-band of an NR slot (e.g., an SBFD slot). As shown by reference number 408, a first CLI-RSSI measurement resource may be associated with a first guard band and a second CLI-RSSI measurement resource may be associated with a second guard band. The first guard band and the second guard band may be associated with a same NR slot (e.g., an SBFD slot).

As indicated above, FIG. 4 is provided as an example. Other examples may differ from what is described with regard to FIG. 4.

FIG. 5 is a diagram illustrating an example process 500 performed, for example, at a UE or an apparatus of a UE, in accordance with the present disclosure. Example process 500 is an example where the apparatus or the UE (e.g., UE 120) performs operations associated with techniques for indicating UE features associated with CLI measurement and reporting.

As shown in FIG. 5, in some aspects, process 500 may include transmitting, via capability signaling, an indication of one or more UE features associated with L1 CLI measurement and reporting, wherein the one or more UE features includes a support of semi-persistent CLI resources for L1-based aperiodic CLI reporting (block 510). For example, the UE (e.g., using transmission component 704 and/or communication manager 706, depicted in FIG. 7) may transmit, via capability signaling, an indication of one or more UE features associated with L1 CLI measurement and reporting, wherein the one or more UE features includes a support of semi-persistent CLI resources for L1-based aperiodic CLI reporting, as described above.

As further shown in FIG. 5, in some aspects, process 500 may include receiving, based at least in part on the capability signaling, a configuration that indicates an L1 CLI resource for the L1 CLI measurement and a configuration for CLI reporting (block 520). For example, the UE (e.g., using reception component 702 and/or communication manager 706, depicted in FIG. 7) may receive, based at least in part on the capability signaling, a configuration that indicates an L1 CLI resource for the L1 CLI measurement and a configuration for CLI reporting, as described above.

As further shown in FIG. 5, in some aspects, process 500 may include transmitting a CLI report based at least in part on the configuration for CLI reporting, wherein the CLI report indicates an aperiodic CLI measurement associated with the L1 CLI resource (block 530). For example, the UE (e.g., using transmission component 704 and/or communication manager 706, depicted in FIG. 7) may transmit a CLI report based at least in part on the configuration for CLI reporting, wherein the CLI report indicates an aperiodic CLI measurement associated with the L1 CLI resource, as described above.

Process 500 may include additional aspects, such as any single aspect or any combination of aspects described below and/or in connection with one or more other processes described elsewhere herein.

In a first aspect, the one or more UE features includes one or more of a support of aperiodic CLI reporting associated with aperiodic CLI resources, or a CLI report quantity, wherein the CLI report quantity is associated with one or more of a CLI-RSSI or a CLI-SRS-RSRP.

In a second aspect, alone or in combination with the first aspect, the one or more UE features includes one or more of a support of aperiodic CLI reporting associated with one or more of aperiodic, semi-persistent, or periodic CLI resources, wherein the CLI resources includes CLI-RSSI resources or CLI-SRS-RSRP resources, or a CLI report quantity, wherein the CLI report quantity is associated with one or more of a CLI-RSSI or a CLI-SRS-RSRP.

In a third aspect, alone or in combination with one or more of the first and second aspects, the one or more UE features includes one or more of a support of aperiodic CLI reporting associated with one or more of periodic, semi-persistent, or aperiodic CLI-RSSI resources, a CLI report quantity, wherein the CLI report quantity is associated with one or more of a CLI-RSSI or a CLI-SRS-RSRP, or a maximum number of aperiodic CSI report settings per BWP for the CLI report.

In a fourth aspect, alone or in combination with one or more of the first through third aspects, the capability signaling indicates a number of CSI reports for which the UE is able to measure and process reference signals simultaneously in a CC, and a CSI report includes the CLI report.

In a fifth aspect, alone or in combination with one or more of the first through fourth aspects, the one or more UE features includes one or more of a support of aperiodic CLI reporting associated with one or more of periodic, semi-persistent, or aperiodic CLI-RSSI resources, a CLI report quantity, wherein the CLI report quantity is associated with one or more of a CLI-RSSI or a CLI-SRS-RSRP, a maximum number of aperiodic CSI report settings per BWP for the CLI report, a maximum number of CLI reports for which the UE is able to measure and process CLI resources simultaneously in a CC, or a maximum number of CLI reports for which the UE is able to measure and process CLI resources simultaneously across one or more CCs.

In a sixth aspect, alone or in combination with one or more of the first through fifth aspects, the capability signaling indicates a number of CSI reports for which the UE is able to measure and process CLI resources simultaneously in a CC, and a CSI report includes the CLI report.

In a seventh aspect, alone or in combination with one or more of the first through sixth aspects, the one or more UE features includes one or more of a support of aperiodic CLI reporting associated with one or more of periodic, semi-persistent, or aperiodic CLI resources, a CLI report quantity, wherein the CLI report quantity is associated with one or more of a CLI-RSSI or a CLI-SRS-RSRP, a maximum number of aperiodic CSI report settings per BWP for the CLI report, a maximum number of CLI reports for which the UE is able to measure and process CLI resources simultaneously in a CC, and a maximum number of CLI reports for which the UE is able to measure and process CLI resources simultaneously across one or more CCs, a maximum number of configured CLI measurement resources per CC or per BWP, a maximum number of configured CLI measurement resources across the one or more CCs, a maximum number of simultaneous CLI resources per CC, a maximum number of simultaneous CLI resources in active BWPs across the one or more CCs, a maximum number of measured CLI resources per slot per CC, or a maximum number of measured CLI resources per slot across the one or more CCs.

In an eighth aspect, alone or in combination with one or more of the first through seventh aspects, the capability signaling indicates: a maximum number of active or simultaneous CLI resources per CC or across one or more CC, and a maximum number of NZP-CSI-RS resources.

In a ninth aspect, alone or in combination with one or more of the first through eighth aspects, the L1 CLI resource is active for a duration of time depending on whether the L1 CLI resource is an aperiodic CLI resource, a semi-persistent CLI resource, or a periodic CLI resource.

In a tenth aspect, alone or in combination with one or more of the first through ninth aspects, the capability signaling indicates a maximum number that includes: a number of active or simultaneous CLI resources per CC or across one or more CCs, and a number of NZP-CSI-RS resources.

In an eleventh aspect, alone or in combination with one or more of the first through tenth aspects, the one or more UE features includes a support of periodic CLI resources for L1-based aperiodic CLI reporting.

In a twelfth aspect, alone or in combination with one or more of the first through eleventh aspects, the one or more UE features are associated with an FDM of a downlink signal or channel reception and CLI measurements, and the one or more UE features includes one or more of a simultaneous reception of downlink signals or channels in a downlink sub-band and an L1 CLI measurement resource in an uplink sub-band, or a simultaneous reception of downlink signals or channels in a first downlink sub-band and an L1 CLI measurement resource in a second downlink sub-band.

In a thirteenth aspect, alone or in combination with one or more of the first through twelfth aspects, the one or more UE features includes a support of L1 CLI reporting and a support of L3 CLI reporting, and L1 CLI resources are not configured simultaneously with L3 CLI resources.

In a fourteenth aspect, alone or in combination with one or more of the first through thirteenth aspects, the one or more UE features includes a support of L1 CLI reporting and a support of L3 CLI reporting, and L1 CLI resources are configured simultaneously with L3 CLI resources based at least in part on a UE capability.

In a fifteenth aspect, alone or in combination with one or more of the first through fourteenth aspects, the one or more UE features includes a support of a simultaneous configuration of L1 CLI resources and L3 CLI resources, and a counting of a maximum number of configured L1 CLI resources is separate from a counting of a maximum number of configured L3 CLI resources.

In a sixteenth aspect, alone or in combination with one or more of the first through fifteenth aspects, the one or more UE features includes a support of a simultaneous configuration of L1 CLI resources and L3 CLI resources, and the L1 CLI resources and the L3 CLI resources are both counted toward a same reported capability of a maximum number of CLI resources.

In a seventeenth aspect, alone or in combination with one or more of the first through sixteenth aspects, the configuration indicates a plurality of L1 CLI resources, and a quantity associated with the plurality of L1 CLI resources satisfies a maximum capability associated with the UE.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, at a network node or an apparatus of a network node, in accordance with the present disclosure. Example process 600 is an example where the apparatus or the network node (e.g., network node 110) performs operations associated with techniques for indicating UE features associated with CLI measurement and reporting.

As shown in FIG. 6, in some aspects, process 600 may include receiving, via capability signaling, an indication of one or more UE features associated with L1 CLI measurement and reporting, wherein the one or more UE features includes a support of semi-persistent CLI resources for L1-based aperiodic CLI reporting (block 610). For example, the network node (e.g., using reception component 802 and/or communication manager 806, depicted in FIG. 8) may receive, via capability signaling, an indication of one or more UE features associated with L1 CLI measurement and reporting, wherein the one or more UE features includes a support of semi-persistent CLI resources for L1-based aperiodic CLI reporting, as described above.

As further shown in FIG. 6, in some aspects, process 600 may include transmitting, based at least in part on the capability signaling, a configuration that indicates an L1 CLI resource for the L1 CLI measurement and a configuration for CLI reporting (block 620). For example, the network node (e.g., using transmission component 804 and/or communication manager 806, depicted in FIG. 8) may transmit, based at least in part on the capability signaling, a configuration that indicates an L1 CLI resource for the L1 CLI measurement and a configuration for CLI reporting, as described above.

As further shown in FIG. 6, in some aspects, process 600 may include receiving a CLI report based at least in part on the configuration for CLI reporting, wherein the CLI report indicates an aperiodic CLI measurement associated with the L1 CLI resource (block 630). For example, the network node (e.g., using reception component 802 and/or communication manager 806, depicted in FIG. 8) may receive a CLI report based at least in part on the configuration for CLI reporting, wherein the CLI report indicates an aperiodic CLI measurement associated with the L1 CLI resource, as described above.

Process 600 may include additional aspects, such as any single aspect or any combination of aspects described below and/or in connection with one or more other processes described elsewhere herein.

In a first aspect, the one or more UE features includes one or more of a support of aperiodic CLI reporting associated with aperiodic CLI resources, or a CLI report quantity, wherein the CLI report quantity is associated with one or more of a CLI-RSSI or a CLI-SRS-RSRP.

In a second aspect, alone or in combination with the first aspect, the one or more UE features includes one or more of a support of aperiodic CLI reporting associated with one or more of aperiodic, semi-persistent, or periodic CLI resources, wherein the CLI resources includes CLI-RSSI resources or CLI-SRS-RSRP resources, or a CLI report quantity, wherein the CLI report quantity is associated with one or more of a CLI-RSSI or a CLI-SRS-RSRP.

In a third aspect, alone or in combination with one or more of the first and second aspects, the one or more UE features includes one or more of a support of aperiodic CLI reporting associated with one or more of periodic, semi-persistent, or aperiodic CLI-RSSI resources, a CLI report quantity, wherein the CLI report quantity is associated with one or more of a CLI-RSSI or a CLI-SRS-RSRP, or a maximum number of aperiodic CSI report settings per BWP for the CLI report.

In a fourth aspect, alone or in combination with one or more of the first through third aspects, the capability signaling indicates a number of CSI reports for which the UE is able to measure and process reference signals simultaneously in a CC, and a CSI report includes the CLI report.

In a fifth aspect, alone or in combination with one or more of the first through fourth aspects, the one or more UE features includes one or more of a support of aperiodic CLI reporting associated with one or more of periodic, semi-persistent, or aperiodic CLI-RSSI resources, a CLI report quantity, wherein the CLI report quantity is associated with one or more of a CLI-RSSI or a CLI-SRS-RSRP, a maximum number of aperiodic CSI report settings per BWP for the CLI report, a maximum number of CLI reports for which the UE is able to measure and process CLI resources simultaneously in a CC, or a maximum number of CLI reports for which the UE is able to measure and process CLI resources simultaneously across one or more CCs.

In a sixth aspect, alone or in combination with one or more of the first through fifth aspects, the capability signaling indicates a number of CSI reports for which the UE is able to measure and process CLI resources simultaneously in a CC, and a CSI report includes the CLI report.

In a seventh aspect, alone or in combination with one or more of the first through sixth aspects, the one or more UE features includes one or more of a support of aperiodic CLI reporting associated with one or more of periodic, semi-persistent, or aperiodic CLI resources, a CLI report quantity, wherein the CLI report quantity is associated with one or more of a CLI-RSSI or a CLI-SRS-RSRP, a maximum number of aperiodic CSI report settings per BWP for the CLI report, a maximum number of CLI reports for which the UE is able to measure and process CLI resources simultaneously in a CC, and a maximum number of CLI reports for which the UE is able to measure and process CLI resources simultaneously across one or more CCs, a maximum number of configured CLI measurement resources per CC or per BWP, a maximum number of configured CLI measurement resources across the one or more CCs, a maximum number of simultaneous CLI resources per CC, a maximum number of simultaneous CLI resources in active BWPs across the one or more CCs, a maximum number of measured CLI resources per slot per CC, or a maximum number of measured CLI resources per slot across the one or more CCs.

In an eighth aspect, alone or in combination with one or more of the first through seventh aspects, the capability signaling indicates: a maximum number of active or simultaneous CLI resources per CC or across one or more CC, and a maximum number of NZP-CSI-RS resources.

In a ninth aspect, alone or in combination with one or more of the first through eighth aspects, the L1 CLI resource is active for a duration of time depending on whether the L1 CLI resource is an aperiodic CLI resource, a semi-persistent CLI resource, or a periodic CLI resource.

In a tenth aspect, alone or in combination with one or more of the first through ninth aspects, the capability signaling indicates a maximum number that includes: a number of active or simultaneous CLI resources per CC or across one or more CCs, and a number of NZP-CSI-RS resources.

In an eleventh aspect, alone or in combination with one or more of the first through tenth aspects, the one or more UE features includes a support of periodic CLI resources for L1-based aperiodic CLI reporting.

In a twelfth aspect, alone or in combination with one or more of the first through eleventh aspects, the one or more UE features are associated with an FDM of a downlink signal or channel reception and CLI measurements, and the one or more UE features includes one or more of a simultaneous reception of downlink signals or channels in a downlink sub-band and an L1 CLI measurement resource in an uplink sub-band, or a simultaneous reception of downlink signals or channels in a first downlink sub-band and an L1 CLI measurement resource in a second downlink sub-band.

In a thirteenth aspect, alone or in combination with one or more of the first through twelfth aspects, the one or more UE features includes a support of L1 CLI reporting and a support of L3 CLI reporting, and L1 CLI resources are not configured simultaneously with L3 CLI resources.

In a fourteenth aspect, alone or in combination with one or more of the first through thirteenth aspects, the one or more UE features includes a support of L1 CLI reporting and a support of L3 CLI reporting, and L1 CLI resources are configured simultaneously with L3 CLI resources based at least in part on a UE capability.

In a fifteenth aspect, alone or in combination with one or more of the first through fourteenth aspects, the one or more UE features includes a support of a simultaneous configuration of L1 CLI resources and L3 CLI resources, and a counting of a maximum number of configured L1 CLI resources is separate from a counting of a maximum number of configured L3 CLI resources.

In a sixteenth aspect, alone or in combination with one or more of the first through fifteenth aspects, the one or more UE features includes a support of a simultaneous configuration of L1 CLI resources and L3 CLI resources, and the L1 CLI resources and the L3 CLI resources are both counted toward a same reported capability of a maximum number of CLI resources.

In a seventeenth aspect, alone or in combination with one or more of the first through sixteenth aspects, the configuration indicates a plurality of L1 CLI resources, and a quantity associated with the plurality of L1 CLI resources satisfies a maximum capability associated with the UE.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication, in accordance with the present disclosure. The apparatus 700 may be a UE, or a UE may include the apparatus 700. In some aspects, the apparatus 700 includes a reception component 702, a transmission component 704, and/or a communication manager 706, which may be in communication with one another (for example, via one or more buses and/or one or more other components). In some aspects, the communication manager 706 is the communication manager 150 described in connection with FIG. 1. As shown, the apparatus 700 may communicate with another apparatus 708, such as a UE or a network node (such as a CU, a DU, an RU, or a base station), using the reception component 702 and the transmission component 704. The communication manager 706 may be included in, or implemented via, a processing system (for example, the processing system 140 described in connection with FIG. 1) of the UE.

In some aspects, the apparatus 700 may be configured to perform one or more operations described herein in connection with FIGS. 3-4. Additionally, or alternatively, the apparatus 700 may be configured to perform one or more processes described herein, such as process 500 of FIG. 5, or a combination thereof. In some aspects, the apparatus 700 and/or one or more components shown in FIG. 7 may include one or more components of the UE described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications, and may provide the processed signals to the one or more other components of the apparatus 700. In some aspects, the reception component 702 may include one or more components of the UE described above in connection with FIG. 1, such as a radio, one or more RF chains, one or more transceivers, or one or more modems, each of which may in turn be coupled with one or more antennas of the UE.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications, and may transmit the processed signals to the apparatus 708. In some aspects, the transmission component 704 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 704 may be co-located with the reception component 702.

The communication manager 706 may support operations of the reception component 702 and/or the transmission component 704. For example, the communication manager 706 may receive information associated with configuring reception of communications by the reception component 702 and/or transmission of communications by the transmission component 704. Additionally, or alternatively, the communication manager 706 may generate and/or provide control information to the reception component 702 and/or the transmission component 704 to control reception and/or transmission of communications.

The transmission component 704 may transmit, via capability signaling, an indication of one or more UE features associated with L1 CLI measurement and reporting, wherein the one or more UE features includes a support of semi-persistent CLI resources for L1-based aperiodic CLI reporting. The reception component 702 may receive, based at least in part on the capability signaling, a configuration that indicates an L1 CLI resource for the L1 CLI measurement and a configuration for CLI reporting. The transmission component 704 may transmit a CLI report based at least in part on the configuration for CLI reporting, wherein the CLI report indicates an aperiodic CLI measurement associated with the L1 CLI resource.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram of an example apparatus 800 for wireless communication, in accordance with the present disclosure. The apparatus 800 may be a network node, or a network node may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 155 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 145 described in connection with FIG. 1) of the network node.

In some aspects, the apparatus 800 may be configured to perform one or more operations described herein in connection with FIGS. 3-4. Additionally, or alternatively, the apparatus 800 may be configured to perform one or more processes described herein, such as process 600 of FIG. 6, or a combination thereof. In some aspects, the apparatus 800 and/or one or more components shown in FIG. 8 may include one or more components of the network node described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the network node described above in connection with FIG. 1, such as a radio, one or more RF chains, one or more transceivers, or one or more modems, each of which may in turn be coupled with one or more antennas of the network node. In some aspects, the reception component 802 and/or the transmission component 804 may include or may be included in a network interface. The network interface may be configured to obtain and/or output signals for the apparatus 800 via one or more communications links, such as a backhaul link, a midhaul link, and/or a fronthaul link.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 804 may be co-located with the reception component 802.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The reception component 802 may receive, via capability signaling, an indication of one or more UE features associated with L1 CLI measurement and reporting, wherein the one or more UE features includes a support of semi-persistent CLI resources for L1-based aperiodic CLI reporting. The transmission component 804 may transmit, based at least in part on the capability signaling, a configuration that indicates an L1 CLI resource for the L1 CLI measurement and a configuration for CLI reporting. The reception component 802 may receive a CLI report based at least in part on the configuration for CLI reporting, wherein the CLI report indicates an aperiodic CLI measurement associated with the L1 CLI resource.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a user equipment (UE), comprising: transmitting, via capability signaling, an indication of one or more UE features associated with layer 1 (L1) cross-link interference (CLI) measurement and reporting; receiving, based at least in part on the capability signaling, a configuration that indicates an L1 CLI resource for the L1 CLI measurement and a configuration for CLI reporting; and transmitting a CLI report based at least in part on the configuration for CLI reporting, wherein the CLI report indicates an aperiodic CLI measurement associated with the L1 CLI resource.

Aspect 2: The method of Aspect 1, wherein the one or more UE features includes one or more of: a support of aperiodic CLI reporting associated with aperiodic CLI resources, or a CLI report quantity, wherein the CLI report quantity is associated with one or more of a CLI received signal strength indicator or a CLI sounding reference signal reference signal received power.

Aspect 3: The method of any of Aspects 1-2, wherein the one or more UE features includes one or more of: a support of aperiodic CLI reporting associated with one or more of aperiodic, semi-persistent, or periodic CLI resources, wherein the CLI resources includes CLI received signal strength indicator (RSSI) resources or CLI sounding reference signal reference signal received power (SRS-RSRP) resources, or a CLI report quantity, wherein the CLI report quantity is associated with one or more of a CLI-RSSI or a CLI-SRS-RSRP.

Aspect 4: The method of any of Aspects 1-3, wherein the one or more UE features includes one or more of: a support of aperiodic CLI reporting associated with one or more of periodic, semi-persistent, or aperiodic CLI resources, a CLI report quantity, wherein the CLI report quantity is associated with one or more of a CLI received signal strength indicator or a CLI sounding reference signal reference signal received power, or a maximum number of aperiodic CSI report settings per bandwidth part for the CLI report.

Aspect 5: The method of any of Aspects 1-4, wherein the capability signaling indicates a number of channel state information (CSI) reports for which the UE is able to measure and process reference signals simultaneously in a component carrier, and wherein a CSI report includes the CLI report.

Aspect 6: The method of any of Aspects 1-5, wherein the one or more UE features includes one or more of: a support of aperiodic CLI reporting associated with one or more of periodic, semi-persistent, or aperiodic CLI resources, a CLI report quantity, wherein the CLI report quantity is associated with one or more of a CLI received signal strength indicator or a CLI sounding reference signal reference signal received power, a maximum number of aperiodic CSI report settings per bandwidth part for the CLI report, a maximum number of CLI reports for which the UE is able to measure and process CLI resources simultaneously in a component carrier, or a maximum number of CLI reports for which the UE is able to measure and process CLI resources simultaneously across one or more component carriers.

Aspect 7: The method of any of Aspects 1-6, wherein the capability signaling indicates a number of channel state information (CSI) reports for which the UE is able to measure and process CLI resources simultaneously in a component carrier, and wherein a CSI report includes the CLI report.

Aspect 8: The method of any of Aspects 1-7, wherein the one or more UE features includes one or more of: a support of aperiodic CLI reporting associated with one or more of periodic, semi-persistent, or aperiodic CLI resources, a CLI report quantity, wherein the CLI report quantity is associated with one or more of a CLI-RSSI or a CLI sounding reference signal reference signal received power, a maximum number of aperiodic CSI report settings per bandwidth part (BWP) for the CLI report, a maximum number of CLI reports for which the UE is able to measure and process CLI resources simultaneously in a component carrier, a maximum number of CLI reports for which the UE is able to measure and process CLI resources simultaneously across one or more component carriers, a maximum number of configured CLI measurement resources per component carrier or per BWP, a maximum number of configured CLI measurement resources across the one or more component carriers, a maximum number of simultaneous CLI resources per component carrier, a maximum number of simultaneous CLI resources in active BWPs across the one or more component carriers, a maximum number of measured CLI resources per slot per component carrier, or a maximum number of measured CLI resources per slot across the one or more component carriers.

Aspect 9: The method of any of Aspects 1-8, wherein the capability signaling indicates: a maximum number of active or simultaneous CLI resources per component carrier or across one or more component carriers, and a maximum number of non-zero-power channel state information reference signal resources.

Aspect 10: The method of any of Aspects 1-9, wherein the L1 CLI resource is active for a duration of time depending on whether the L1 CLI resource is an aperiodic CLI resource, a semi-persistent CLI resource, or a periodic CLI resource.

Aspect 11: The method of any of Aspects 1-10, wherein the capability signaling indicates a maximum number that includes: a number of active or simultaneous CLI resources per component carrier or across one or more component carriers, and a number of non-zero-power channel state information reference signal resources.

Aspect 12: The method of any of Aspects 1-11, wherein the one or more UE features includes one or more of: a support of periodic CLI resources for L1-based aperiodic CLI reporting, or a support of semi-persistent CLI resources for L1-based aperiodic CLI reporting.

Aspect 13: The method of any of Aspects 1-12, wherein the one or more UE features are associated with a frequency division multiplexing of a downlink signal or channel reception and CLI measurements, and wherein the one or more UE features includes one or more of: a simultaneous reception of downlink signals or channels in a downlink sub-band and an L1 CLI measurement resource in an uplink sub-band, or a simultaneous reception of downlink signals or channels in a first downlink sub-band and an L1 CLI measurement resource in a second downlink sub-band.

Aspect 14: The method of any of Aspects 1-13, wherein the one or more UE features includes a support of L1 CLI reporting and a support of layer 3 (L3) CLI reporting, and wherein L1 CLI resources are not configured simultaneously with L3 CLI resources.

Aspect 15: The method of any of Aspects 1-14, wherein the one or more UE features includes a support of L1 CLI reporting and a support of layer 3 (L3) CLI reporting, and wherein L1 CLI resources are configured simultaneously with L3 CLI resources based at least in part on a UE capability.

Aspect 16: The method of any of Aspects 1-15, wherein the one or more UE features includes a support of a simultaneous configuration of L1 CLI resources and layer 3 (L3) CLI resources, and wherein a counting of a maximum number of configured L1 CLI resources is separate from a counting of a maximum number of configured L3 CLI resources.

Aspect 17: The method of any of Aspects 1-16, wherein the one or more UE features includes a support of a simultaneous configuration of L1 CLI resources and layer 3 (L3) CLI resources, and wherein the L1 CLI resources and the L3 CLI resources are both counted toward a same reported capability of a maximum number of CLI resources.

Aspect 18: The method of any of Aspects 1-17, wherein the configuration indicates a plurality of L1 CLI resources, and wherein a quantity associated with the plurality of L1 CLI resources satisfies a maximum capability associated with the UE.

Aspect 19: A method of wireless communication performed by a network node, comprising: receiving, via capability signaling, an indication of one or more UE features associated with layer 1 (L1) cross-link interference (CLI) measurement and reporting; transmitting, based at least in part on the capability signaling, a configuration that indicates an L1 CLI resource for the L1 CLI measurement and a configuration for CLI reporting; and receiving a CLI report based at least in part on the configuration for CLI reporting, wherein the CLI report indicates an aperiodic CLI measurement associated with the L1 CLI resource.

Aspect 20: The method of Aspect 19, wherein the one or more UE features includes one or more of: a support of aperiodic CLI reporting associated with aperiodic CLI resources, or a CLI report quantity, wherein the CLI report quantity is associated with one or more of a CLI received signal strength indicator or a CLI sounding reference signal reference signal received power.

Aspect 21: The method of any of Aspects 19-20, wherein the one or more UE features includes one or more of: a support of aperiodic CLI reporting associated with one or more of aperiodic, semi-persistent, or periodic CLI resources, wherein the CLI resources includes CLI received signal strength indicator (RSSI) resources or CLI sounding reference signal reference signal received power (SRS-RSRP) resources, or a CLI report quantity, wherein the CLI report quantity is associated with one or more of a CLI-RSSI or a CLI-SRS-RSRP.

Aspect 22: The method of any of Aspects 19-21, wherein the one or more UE features includes one or more of: a support of aperiodic CLI reporting associated with one or more of periodic, semi-persistent, or aperiodic CLI resources, a CLI report quantity, wherein the CLI report quantity is associated with one or more of a CLI received signal strength indicator or a CLI sounding reference signal reference signal received power, or a maximum number of aperiodic CSI report settings per bandwidth part for the CLI report.

Aspect 23: The method of any of Aspects 19-22, wherein the capability signaling indicates a number of channel state information (CSI) reports for which the UE is able to measure and process reference signals simultaneously in a component carrier, and wherein a CSI report includes the CLI report.

Aspect 24: The method of any of Aspects 19-23, wherein the one or more UE features includes one or more of: a support of aperiodic CLI reporting associated with one or more of periodic, semi-persistent, or aperiodic CLI resources, a CLI report quantity, wherein the CLI report quantity is associated with one or more of a CLI received signal strength indicator or a CLI sounding reference signal reference signal received power, a maximum number of aperiodic CSI report settings per bandwidth part for the CLI report, a maximum number of CLI reports for which a UE is able to measure and process CLI resources simultaneously in a component carrier, or a maximum number of CLI reports for which the UE is able to measure and process CLI resources simultaneously across one or more component carriers.

Aspect 25: The method of any of Aspects 19-24, wherein the capability signaling indicates a number of channel state information (CSI) reports for which the UE is able to measure and process CLI resources simultaneously in a component carrier, and wherein a CSI report includes the CLI report.

Aspect 26: The method of any of Aspects 19-25, wherein the one or more UE features includes one or more of: a support of aperiodic CLI reporting associated with one or more of periodic, semi-persistent, or aperiodic CLI resources, a CLI report quantity, wherein the CLI report quantity is associated with one or more of a CLI-RSSI or a CLI sounding reference signal reference signal received power, a maximum number of aperiodic CSI report settings per bandwidth part (BWP) for the CLI report, a maximum number of CLI reports for which a UE is able to measure and process CLI resources simultaneously in a component carrier, a maximum number of CLI reports for which the UE is able to measure and process CLI resources simultaneously across one or more component carriers, a maximum number of configured CLI measurement resources per component carrier or per BWP, a maximum number of configured CLI measurement resources across the one or more component carriers, a maximum number of simultaneous CLI resources per component carrier, a maximum number of simultaneous CLI resources in active BWPs across the one or more component carriers, a maximum number of measured CLI resources per slot per component carrier, or a maximum number of measured CLI resources per slot across the one or more component carriers.

Aspect 27: The method of any of Aspects 19-26, wherein the capability signaling indicates: a maximum number of active or simultaneous CLI resources per component carrier or across one or more component carriers, and a maximum number of non-zero-power channel state information reference signal resources.

Aspect 28: The method of any of Aspects 19-27, wherein the L1 CLI resource is active for a duration of time depending on whether the L1 CLI resource is an aperiodic CLI resource, a semi-persistent CLI resource, or a periodic CLI resource.

Aspect 29: The method of any of Aspects 19-28, wherein the capability signaling indicates a maximum number that includes: a number of active or simultaneous CLI resources per component carrier or across one or more component carriers, and a number of non-zero-power channel state information reference signal resources.

Aspect 30: The method of any of Aspects 19-29, wherein the one or more UE features includes one or more of: a support of periodic CLI resources for L1-based aperiodic CLI reporting, or a support of semi-persistent CLI resources for L1-based aperiodic CLI reporting.

Aspect 31: The method of any of Aspects 19-30, wherein the one or more UE features are associated with a frequency division multiplexing of a downlink signal or channel reception and CLI measurements, and wherein the one or more UE features includes one or more of: a simultaneous reception of downlink signals or channels in a downlink sub-band and an L1 CLI measurement resource in an uplink sub-band, or a simultaneous reception of downlink signals or channels in a first downlink sub-band and an L1 CLI measurement resource in a second downlink sub-band.

Aspect 32: The method of any of Aspects 19-31, wherein the one or more UE features includes a support of L1 CLI reporting and a support of layer 3 (L3) CLI reporting, and wherein L1 CLI resources are not configured simultaneously with L3 CLI resources.

Aspect 33: The method of any of Aspects 19-32, wherein the one or more UE features includes a support of L1 CLI reporting and a support of layer 3 (L3) CLI reporting, and wherein L1 CLI resources are configured simultaneously with L3 CLI resources based at least in part on a UE capability.

Aspect 34: The method of any of Aspects 19-33, wherein the one or more UE features includes a support of a simultaneous configuration of L1 CLI resources and layer 3 (L3) CLI resources, and wherein a counting of a maximum number of configured L1 CLI resources is separate from a counting of a maximum number of configured L3 CLI resources.

Aspect 35: The method of any of Aspects 19-34, wherein the one or more UE features includes a support of a simultaneous configuration of L1 CLI resources and layer 3 (L3) CLI resources, and wherein the L1 CLI resources and the L3 CLI resources are both counted toward a same reported capability of a maximum number of CLI resources.

Aspect 36: The method of any of Aspects 19-35, wherein the configuration indicates a plurality of L1 CLI resources, and wherein a quantity associated with the plurality of L1 CLI resources satisfies a maximum capability associated with the UE.

Aspect 37: A method of wireless communication performed by a user equipment (UE), comprising: transmitting, via capability signaling, an indication of one or more UE features associated with layer 1 (L1) cross-link interference (CLI) measurement and reporting, wherein the one or more UE features includes a support of semi-persistent CLI resources for L1-based aperiodic CLI reporting; receiving, based at least in part on the capability signaling, a configuration that indicates an L1 CLI resource for the L1 CLI measurement and a configuration for CLI reporting; and transmitting a CLI report based at least in part on the configuration for CLI reporting, wherein the CLI report indicates an aperiodic CLI measurement associated with the L1 CLI resource.

Aspect 38: A method of wireless communication performed by a network node, comprising: receiving, via capability signaling, an indication of one or more UE features associated with layer 1 (L1) cross-link interference (CLI) measurement and reporting, wherein the one or more UE features includes a support of semi-persistent CLI resources for L1-based aperiodic CLI reporting; transmitting, based at least in part on the capability signaling, a configuration that indicates an L1 CLI resource for the L1 CLI measurement and a configuration for CLI reporting; and receiving a CLI report based at least in part on the configuration for CLI reporting, wherein the CLI report indicates an aperiodic CLI measurement associated with the L1 CLI resource.

Aspect 39: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-38.

Aspect 40: An apparatus for wireless communication at a device, the apparatus comprising one or more memories and one or more processors coupled to the one or more memories, the one or more processors configured to cause the device to perform the method of one or more of Aspects 1-38.

Aspect 41: An apparatus for wireless communication, the apparatus comprising at least one means for performing the method of one or more of Aspects 1-38.

Aspect 42: A non-transitory computer-readable medium storing code for wireless communication, the code comprising instructions executable by one or more processors to perform the method of one or more of Aspects 1-38.

Aspect 43: A non-transitory computer-readable medium storing a set of instructions for wireless communication, the set of instructions comprising one or more instructions that, when executed by one or more processors of a device, cause the device to perform the method of one or more of Aspects 1-38.

Aspect 44: A device for wireless communication, the device comprising a processing system that includes one or more processors and one or more memories coupled with the one or more processors, the processing system configured to cause the device to perform the method of one or more of Aspects 1-38.

Aspect 45: An apparatus for wireless communication at a device, the apparatus comprising one or more memories and one or more processors coupled to the one or more memories, the one or more processors individually or collectively configured to cause the device to perform the method of one or more of Aspects 1-38.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (for example, a + a, a + a + a, a + a + b, a + a + c, a + b + b, a + c + c, b + b, b + b + b, b + b + c, c + c, and c + c + c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication, comprising:
one or more memories; and
one or more processors coupled to the one or more memories, the one or more processors individually or collectively configured to:
transmit, via capability signaling, an indication of one or more user equipment (UE) features associated with layer 1 (L1) cross-link interference (CLI) measurement and reporting, wherein the one or more UE features includes a support of semi-persistent CLI resources for L1-based aperiodic CLI reporting;
receive, based at least in part on the capability signaling, a configuration that indicates an L1 CLI resource for the L1 CLI measurement and a configuration for CLI reporting; and
transmit a CLI report based at least in part on the configuration for CLI reporting, wherein the CLI report indicates an aperiodic CLI measurement associated with the L1 CLI resource.

2. The apparatus of claim 1, wherein the one or more UE features includes one or more of:
a support of aperiodic CLI reporting associated with aperiodic CLI resources, or
a CLI report quantity, wherein the CLI report quantity is associated with one or more of a CLI received signal strength indicator or a CLI sounding reference signal reference signal received power.

3. The apparatus of claim 1, wherein the one or more UE features includes one or more of:
a support of aperiodic CLI reporting associated with one or more of aperiodic, semi-persistent, or periodic CLI resources, wherein the CLI resources includes CLI received signal strength indicator (RSSI) resources or CLI sounding reference signal reference signal received power (SRS-RSRP) resources, or
a CLI report quantity, wherein the CLI report quantity is associated with one or more of a CLI-RSSI or a CLI-SRS-RSRP.

4. The apparatus of claim 1, wherein the one or more UE features includes one or more of:
a support of aperiodic CLI reporting associated with one or more of periodic, semi-persistent, or aperiodic CLI resources,
a CLI report quantity, wherein the CLI report quantity is associated with one or more of a CLI received signal strength indicator or a CLI sounding reference signal reference signal received power, or
a maximum number of aperiodic CSI report settings per bandwidth part for the CLI report.

5. The apparatus of claim 1, wherein the capability signaling indicates a number of channel state information (CSI) reports for which the UE is able to measure and process reference signals simultaneously in a component carrier, and wherein a CSI report includes the CLI report.

6. The apparatus of claim 1, wherein the one or more UE features includes one or more of:
a support of aperiodic CLI reporting associated with one or more of periodic, semi-persistent, or aperiodic CLI resources,
a CLI report quantity, wherein the CLI report quantity is associated with one or more of a CLI received signal strength indicator or a CLI sounding reference signal reference signal received power,
a maximum number of aperiodic CSI report settings per bandwidth part for the CLI report,
a maximum number of CLI reports for which the UE is able to measure and process CLI resources simultaneously in a component carrier, or
a maximum number of CLI reports for which the UE is able to measure and process CLI resources simultaneously across one or more component carriers.

7. The apparatus of claim 1, wherein the capability signaling indicates a number of channel state information (CSI) reports for which the UE is able to measure and process CLI resources simultaneously in a component carrier, and wherein a CSI report includes the CLI report.

8. The apparatus of claim 1, wherein the one or more UE features includes one or more of:
a support of aperiodic CLI reporting associated with one or more of periodic, semi-persistent, or aperiodic CLI resources,
a CLI report quantity, wherein the CLI report quantity is associated with one or more of a CLI received signal strength indicator or a CLI sounding reference signal reference signal received power,
a maximum number of aperiodic CSI report settings per bandwidth part (BWP) for the CLI report,
a maximum number of CLI reports for which the UE is able to measure and process CLI resources simultaneously in a component carrier,
a maximum number of CLI reports for which the UE is able to measure and process CLI resources simultaneously across one or more component carriers,
a maximum number of configured CLI measurement resources per component carrier or per BWP,
a maximum number of configured CLI measurement resources across the one or more component carriers,
a maximum number of simultaneous CLI resources per component carrier,
a maximum number of simultaneous CLI resources in active BWPs across the one or more component carriers,
a maximum number of measured CLI resources per slot per component carrier, or
a maximum number of measured CLI resources per slot across the one or more component carriers.

9. The apparatus of claim 1, wherein the capability signaling indicates:
a maximum number of active or simultaneous CLI resources per component carrier or across one or more component carriers, and
a maximum number of non-zero-power channel state information reference signal resources.

10. The apparatus of claim 1, wherein the L1 CLI resource is active for a duration of time depending on whether the L1 CLI resource is an aperiodic CLI resource, a semi-persistent CLI resource, or a periodic CLI resource.

11. The apparatus of claim 1, wherein the capability signaling indicates a maximum number that includes: a number of active or simultaneous CLI resources per component carrier or across one or more component carriers, and a number of non-zero-power channel state information reference signal resources.

12. The apparatus of claim 1, wherein the one or more UE features includes:
a support of periodic CLI resources for L1-based aperiodic CLI reporting.

13. The apparatus of claim 1, wherein the one or more UE features are associated with a frequency division multiplexing of a downlink signal or channel reception and CLI measurements, and wherein the one or more UE features includes one or more of:
a simultaneous reception of downlink signals or channels in a downlink sub-band and an L1 CLI measurement resource in an uplink sub-band, or
a simultaneous reception of downlink signals or channels in a first downlink sub-band and an L1 CLI measurement resource in a second downlink sub-band.

14. The apparatus of claim 1, wherein the one or more UE features includes a support of L1 CLI reporting and a support of layer 3 (L3) CLI reporting, and wherein L1 CLI resources are not configured simultaneously with L3 CLI resources.

15. The apparatus of claim 1, wherein the one or more UE features includes a support of L1 CLI reporting and a support of layer 3 (L3) CLI reporting, and wherein L1 CLI resources are configured simultaneously with L3 CLI resources based at least in part on a UE capability.

16. The apparatus of claim 1, wherein the one or more UE features includes a support of a simultaneous configuration of L1 CLI resources and layer 3 (L3) CLI resources, and wherein a counting of a maximum number of configured L1 CLI resources is separate from a counting of a maximum number of configured L3 CLI resources.

17. The apparatus of claim 1, wherein the one or more UE features includes a support of a simultaneous configuration of L1 CLI resources and layer 3 (L3) CLI resources, and wherein the L1 CLI resources and the L3 CLI resources are both counted toward a same reported capability of a maximum number of CLI resources.

18. The apparatus of claim 1, wherein the configuration indicates a plurality of L1 CLI resources, and wherein a quantity associated with the plurality of L1 CLI resources satisfies a maximum capability associated with the UE.

19. An apparatus for wireless communication, comprising:
one or more memories; and
one or more processors coupled to the one or more memories, the one or more processors individually or collectively configured to:
receive, via capability signaling, an indication of one or more user equipment (UE) features associated with layer 1 (L1) cross-link interference (CLI) measurement and reporting, wherein the one or more UE features includes a support of semi-persistent CLI resources for L1-based aperiodic CLI reporting;
transmit, based at least in part on the capability signaling, a configuration that indicates an L1 CLI resource for the L1 CLI measurement and a configuration for CLI reporting; and
receive a CLI report based at least in part on the configuration for CLI reporting, wherein the CLI report indicates an aperiodic CLI measurement associated with the L1 CLI resource.

20. A method of wireless communication performed by a user equipment (UE), comprising:
transmitting, via capability signaling, an indication of one or more UE features associated with layer 1 (L1) cross-link interference (CLI) measurement and reporting, wherein the one or more UE features includes a support of semi-persistent CLI resources for L1-based aperiodic CLI reporting;
receiving, based at least in part on the capability signaling, a configuration that indicates an L1 CLI resource for the L1 CLI measurement and a configuration for CLI reporting; and
transmitting a CLI report based at least in part on the configuration for CLI reporting, wherein the CLI report indicates an aperiodic CLI measurement associated with the L1 CLI resource.
